(19) United States
(12) Patent Application Publication
(10) Pub. No.: US 2026/0364461 A1
(43) Pub. Date: Nov. 19, 2026

(54) HEALTH POINT ADJUSTMENT METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Yajing XU, Shenzhen (CN)

(21) Appl. No.: 19/728,570

(22) Filed: Jul. 2, 2026

Related U.S. Application Data
(63) Continuation of application No. PCT/CN2025/106825, filed on Jul. 3, 2025.

(30) Foreign Application Priority Data
Aug. 19, 2024 (CN) 202411143682.1

(51) Int. Cl. A63F 13/58

(52) U.S. Cl. CPC A63F 13/58

(57) ABSTRACT

This application discloses a health point adjustment method performed by a computer device. The method includes: displaying a player-controlled virtual character in a world scene and health points of the virtual character; in response to a trigger operation for a round-based battle, updating health points of the player-controlled virtual character in the round-based battle scene and controlling a first pet character possessed by the virtual character to engage with a second pet character in a round-based battle scene; adjusting the health points of the player-controlled virtual character based on a battle result between the first pet character and the second pet character; and updating the health points of the player-controlled virtual character in the world scene based on the health points of the player-controlled virtual character in the round-based battle scene after exiting the round-based battle scene. This establishes a connection between the two scenes, and enriches health point-related mechanisms.

### CROSS-REFERENCE TO RELATED APPLICATIONS

This application is a continuation application of PCT Patent Application No. PCT/CN2025/106825, entitled “HEALTH POINT ADJUSTMENT METHOD AND APPARATUS, DEVICE, MEDIUM, AND PROGRAM PRODUCT” filed on Jul. 3, 2025, which claims priority to Chinese Patent Application No. 202411143682.1, entitled “HEALTH POINT ADJUSTMENT METHOD AND APPARATUS, DEVICE, MEDIUM, AND PROGRAM PRODUCT” filed on Aug. 19, 2024, both of which are incorporated herein by reference in their entirety.

### FIELD OF THE TECHNOLOGY

Embodiments of this application relate to the field of human-computer interaction, and in particular, to a health point adjustment method and apparatus, a device, a medium, and a program product.

### BACKGROUND OF THE DISCLOSURE

A round-based role-playing game (RPG) includes that: in a world scene, a player-controlled virtual character explores in a world map. In a round-based battle scene, the player-controlled virtual character engages in a round-based battle with an opponent unit (a wild pet character or a pet character belonging to another virtual character) in a battle map. The world scene is alternatively referred to as a non-battle scene, and the round-based battle scene is alternatively referred to as a battle scene.

In the related art, the player-controlled virtual character has health points. When the health points drop to zero, the player-controlled virtual character cannot act in the world map, and needs to go to a specified position to restore health points before continuing to act.

However, a health point-related mechanism is typically only associated with activities in the world scene, and only takes effect in the world scene. The related mechanism is monotonous and lacks diversity.

### SUMMARY

This application provides a health point adjustment method and apparatus, a device, a medium, and a program product. The technical solution includes at least one of the following aspects.

According to an aspect of embodiments of this application, a method for adjusting health points of a player-controlled virtual character in a virtual battle is performed by a computer device and the method includes:
displaying a graphical user interface including a player-controlled virtual character located in a world scene and health points of the player-controlled virtual character, the player-controlled virtual character possessing a first pet character, and the health points indicating a health attribute of the player-controlled virtual character;
in response to a trigger operation for a round-based battle on the graphical user interface, switching from the world scene to a round-based battle scene;
updating health points of the player-controlled virtual character in the round-based battle scene based on the health points of the player-controlled virtual character in the world scene;
controlling the first pet character to engage in the round-based battle with a second pet character in the round-based battle scene;
adjusting the health points of the player-controlled virtual character in the round-based battle scene based on a battle result between the first pet character and the second pet character; and
updating the health points of the player-controlled virtual character in the world scene based on the health points of the player-controlled virtual character in the round-based battle scene after exiting the round-based battle scene.

According to another aspect of this application, a computer device is provided. The computer device includes a processor and a memory. The memory has at least one program stored therein; and the processor is configured to execute at least one program in the memory, to implement the health point adjustment method.

According to another aspect of the embodiments of this application, a non-transitory computer-readable storage medium is provided. The computer-readable storage medium has at least one program stored therein. The at least one program, when loaded and executed by a processor of a computer device, causes the computer device to implement the health point adjustment method.

The technical solutions provided in the embodiments of this application can achieve the following beneficial effects:

According to the method, the health points of the player-controlled virtual character in the round-based battle scene and the health points of the player-controlled virtual character in the world scene are adjusted based on the battle result between the first pet character and the second pet character. This establishes a connection between the health points in the two scenes, and enriches health point-related mechanisms. In this way, the health points not only take effect in the world scene, but also can be applied to the round-based battle scene.

In other words, according to the method, the health points of the player-controlled virtual character indicate the health attribute of the player-controlled virtual character in the world scene, and the health attribute of the player-controlled virtual character in the round-based battle scene. When the first pet character possessed by the player-controlled virtual character engages in a round-based battle with another pet character, a battle result of the round-based battle can directly affect the health attributes of the player-controlled virtual character in the round-based battle scene and the world scene. This enriches gameplay mechanisms of the health points. In this way, the health points not only take effect in the world scene, but also can be applied to the round-based battle scene, to increase playability.

### BRIEF DESCRIPTION OF THE DRAWINGS

To describe the technical solutions in the embodiments of this application more clearly, the following briefly describes the accompanying drawings required for describing the embodiments. The accompanying drawings in the following description show merely some embodiments of this application, and a person of ordinary skill in the art may still derive other drawings from these accompanying drawings without creative efforts.

FIG. 1 is a schematic diagram of a computer system according to an exemplary embodiment of this application.

FIG. 2 is a schematic diagram of a health point adjustment method according to an exemplary embodiment of this application.

FIG. 3 is a flowchart of a health point adjustment method according to an exemplary embodiment of this application.

FIG. 4 is a flowchart of a health point adjustment method according to an exemplary embodiment of this application.

FIG. 5 is a flowchart of a health point adjustment method according to an exemplary embodiment of this application.

FIG. 6 is a schematic diagram of a health point adjustment method according to an exemplary embodiment of this application.

FIG. 7 is a schematic diagram of a health point adjustment method according to an exemplary embodiment of this application.

FIG. 8 is a schematic diagram of a health point adjustment method according to an exemplary embodiment of this application.

FIG. 9 is a flowchart of a health point adjustment method according to an exemplary embodiment of this application.

FIG. 10 is a flowchart of a health point adjustment method according to an exemplary embodiment of this application.

FIG. 11 is a schematic diagram of a health point-related mechanism according to an exemplary embodiment of this application.

FIG. 12 is a schematic diagram of a health point adjustment method according to an exemplary embodiment of this application.

FIG. 13 is a schematic diagram of a health point adjustment method according to an exemplary embodiment of this application.

FIG. 14 is a schematic diagram of a health point adjustment method according to an exemplary embodiment of this application.

FIG. 15 is a schematic diagram of a health point adjustment method according to an exemplary embodiment of this application.

FIG. 16 is a schematic diagram of a health point adjustment method according to an exemplary embodiment of this application.

FIG. 17 is a block diagram of a health point adjustment apparatus according to an exemplary embodiment of this application.

FIG. 18 is a structural block diagram of a computer device according to an exemplary embodiment of this application.

### DESCRIPTION OF EMBODIMENTS

To make objectives, technical solutions, and advantages of this application clearer, the following further describes implementations of this application in detail with reference to the accompanying drawings.

Exemplary embodiments will be described in detail herein, and examples of the exemplary embodiments are shown in the accompanying drawings. When the following description involves the accompanying drawings, unless otherwise denoted, the same numerals in different accompanying drawings denote the same or similar elements. The implementations described in the following exemplary embodiments do not indicate all implementations consistent with this application. Instead, the implementations are merely examples of apparatuses and methods that are described in detail in the appended claims and that are consistent with some aspects of this application.

Terms used in this application are merely for the purpose of describing specific embodiments, but are not intended to limit this application. The singular forms “a”, “the”, and “this” used in this application and the appended claims are also intended to include plural forms, unless otherwise specified in the context clearly. The term “and/or” used herein indicates and includes any or all combinations of one or more associated listed items.

Object information (including but not limited to object equipment information, object personal information, and the like) and data (including but not limited to data configured for analysis, stored data, displayed data, and the like) involved in this application are all information and data authorized by objects or fully authorized by all parties, and collection, use, and processing of relevant data need to comply with relevant laws, regulations, and standards of relevant countries and regions.

Although terms “first”, “second”, and the like may be used in this application to describe various pieces of information, these pieces of information are not limited by the terms. These terms are merely used to distinguish information of the same type from one another. For example, without departing from the scope of this application, a first parameter may alternatively be referred to as a second parameter. Similarly, the second parameter may alternatively be referred to as a first parameter. Depending on the context, for example, the term “if” used herein may be explained as “while . . . ” or “when . . . ” or “in response to determining”.

First, some terms involved in this application are explained.

Virtual scene: it refers to a virtual scene displayed (or provided) when an application program runs on a terminal. The virtual scene may be a simulated environment scene of a real world, or may be a semi-simulated and semi-fictional three-dimensional environment scene, or may be a purely fictional three-dimensional environment scene. The virtual scene may be any one of a two-dimensional virtual scene, a 2.5-dimensional virtual scene, or a three-dimensional virtual scene. The following embodiments are described by using an example in which the virtual scene is a three-dimensional virtual scene. This is not limited herein.

Player-controlled virtual character: it refers to a movable object played by a player in a virtual world. The player-controlled virtual character may be a virtual person, a virtual animal, or an animation person, such as a person or an animal displayed in a three-dimensional virtual world. In an embodiment, the player-controlled virtual character is a three-dimensional model created through a skeletal animation technology. Each player-controlled virtual character has its own shape and volume in the three-dimensional virtual world and occupies a part of the space in the three-dimensional virtual world.

Pet character: it refers to a movable object controlled by artificial intelligence (AI) or the player in the virtual world. The pet character may be a virtual creature, a virtual animal, a virtual monster, a virtual spirit, a virtual pet character, or the like, such as a movable object that is displayed in the three-dimensional virtual world and is in the form of an animal or in another form. The player-controlled virtual character may perform at least one of interactive operations, such as capturing, raising, and upgrading, on the pet character. The pet character may assist the player-controlled virtual character in performing at least one of interactive operations, such as collecting, battling, and changing a tile.

World scene: it refers to a scene corresponding to a world map. When the world scene is displayed on a user interface (UI), one or more tiles on the world map may be displayed on the UI. For example, one or more tiles on the world map where the player-controlled virtual character or a first pet character is currently located, as well as some interface elements related to the player-controlled virtual character, the first pet character, a second pet character, and the like are displayed on the UI.

Round-based battle scene: it refers to a scene corresponding to a battle map. The battle map is a part of the world map, or the battle map and the world map are different maps. When a round-based battle scene is displayed on the UI, the battle map may be displayed on the UI, for example, all or some of tiles included in the battle map are displayed. For example, one or more tiles on the battle map where the player-controlled virtual character or the pet character is currently located, as well as some interface elements related to the player-controlled virtual character, the pet character, and the like are displayed on the UI.

Switching between the world scene and the round-based battle scene can be implemented, such as switching from the world scene to the round-based battle scene, or switching from the round-based battle scene to the world scene.

A virtual camera may adopt different shooting perspectives when the world scene and the round-based battle scene are displayed. For example, when the world scene is displayed, the virtual camera shoots the world scene from the perspective of the player-controlled virtual character (such as a first-person perspective or a third-person perspective of the player-controlled virtual character), to obtain a display image of the world scene. When the round-based battle scene is displayed, the virtual camera shoots the round-based battle scene from a top-down view or an intermediate angle (for example, the virtual camera is located between two parties engaging in a battle and at an oblique upward angle), to obtain a display image of the round-based battle scene. In an embodiment, in the world scene and the round-based battle scene, in addition to the foregoing difference in the shooting perspectives, allowed user operations may be different. For example, when the world scene is displayed, a user is allowed to manually adjust a viewing angle, or is allowed to control the movement of the player-controlled virtual character or the pet character. When the round-based battle scene is displayed, a user is not allowed to manually adjust a viewing angle, is not allowed to manually control the movement of the player-controlled virtual character or the pet character, or the like.

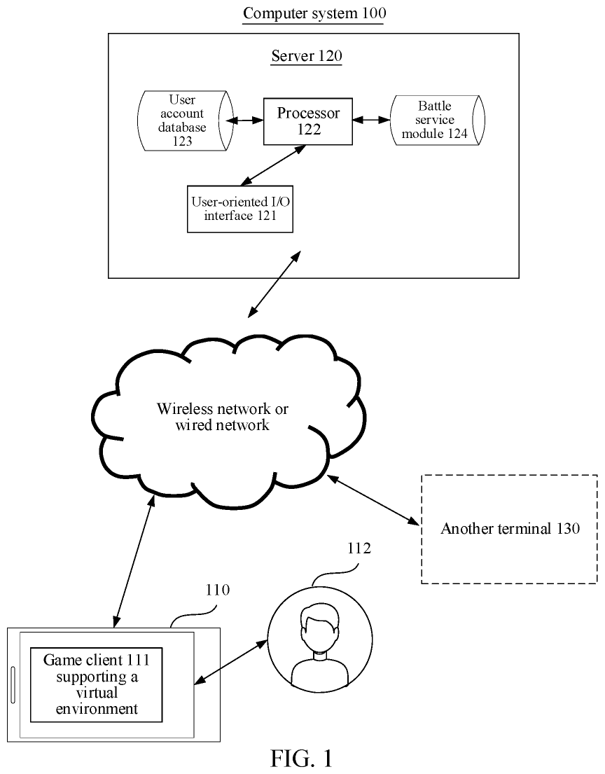

FIG. 1 is a schematic diagram of a computer system 100 according to an exemplary embodiment of this application. The computer system 100 includes: a terminal 110 and a server 120.

A game client 111 supporting a virtual environment is loaded and run on the first terminal 110. When the game client 111 runs on the terminal 110, a UI of the game client 111 is displayed on a screen of the terminal 110. The game client 111 may be any one of a virtual reality (VR) application program, an augmented reality (AR) application program, a three-dimensional map program, a VR game, an AR game, a first-person shooting (FPS) game, a third-person shooting (TPS) game, a multiplayer online battle arena (MOBA) game, and a strategy-based board and card game. In the embodiments of this application, the terms “object”, “user”, “account”, “player”, and the like have a same meaning. This is not limited in this application.

The first terminal 110 is a terminal used by a user 112. The user 112 uses the first terminal 110 to control a first virtual character in a virtual world to perform activities. The first virtual character serves as a player-controlled virtual character. The activities include, but are not limited to, at least one of adjusting a body posture, walking, running, jumping, riding, driving, aiming, picking up, capturing a pet character, controlling a pet character, raising a pet character, using a pet character for picking, using a pet character for a battle, using a throwable prop, and attacking another virtual character. Exemplarily, the first virtual character is a first virtual person, such as a simulated person object or an animated person object.

The terminal 110 may refer to one of a plurality of terminals. In this embodiment, a description is made by only using the terminal 110 as an example. A device type of the terminal 110 includes at least one of a smartphone, a tablet computer, an e-book reader, a Moving Picture Experts Group Audio Layer III (MP3) player, a Moving Picture Experts Group Audio Layer IV (MP4) player, a laptop portable computer, and a desktop computer.

Only one terminal is shown in FIG. 1, but in different embodiments, other terminals 130 access the server 120. In an embodiment, one or more other terminals 130 are terminals corresponding to a developer. A development and editing platform for the game client 111 supporting the virtual environment is loaded on the other terminals 130. The developer may edit and update the game client 111 on the other terminals 130 and transmit an updated game client package to the server 120 over a wired network or a wireless network. The terminal 110 may download the game client package from the server 120 to update the game client 111.

The terminal 110 and the other terminals 130 are connected to the server 120 via a wireless network or a wired network.

The server 120 is a network device, including at least one of one server, a plurality of servers, a cloud computing platform, and a virtualization center. The server 120 is configured to provide a backend service for the game client 111 supporting the virtual environment. In an embodiment, the server 120 is responsible for primary computing work, and the terminal 110 is responsible for secondary computing work. Alternatively, the server 120 is responsible for the secondary computing work, and the terminal 110 is responsible for the primary computing work. Alternatively, a distributed computing architecture may be adopted between the server 120 and the terminal 110 for collaborative computing.

In an embodiment, the server 120 includes a user-oriented input/output (I/O) interface 121, a processor 122, a user account database 123, and a battle service module 124. The processor 122 is configured to load instructions stored in the server 120 and process data in the user account database 123 and the battle service module 124. The user account database 123 is configured to store data of user accounts used on the first terminal 110 and the other terminals 130, such as avatars of the user accounts, nicknames of the user accounts, battle effectiveness indexes of the user accounts, and service zones of the user accounts. The battle service module 124 is configured to provide a plurality of battle modes for battles between users, such as a 1V1 battle mode, a 3V3 battle mode, a 5V5 battle mode, or a battle mode in which one or more users form a faction, and a plurality of (more than three) factions battle against one another, and ranked and eliminated based on battle results, to determine final rankings. The user-oriented I/O interface 121 is configured to establish, through a wireless network or a wired network, communication with the first terminal 110 and/or the other terminals 130.

A person skilled in the art may understand that more or fewer terminals 110 may be provided. For example, only one terminal 110 is provided, or dozens or hundreds of terminals 110 are provided, or more terminals are provided. A quantity and the device type of the terminal 110 are not limited in the embodiments of this application.

A round-based role-playing game (RPG) includes that: in a world scene, a player-controlled virtual character explores in a world map. In a round-based battle scene, the player-controlled virtual character engages in a round-based battle with an opponent unit (a wild pet character or a pet character belonging to another virtual character) in a battle map. The world scene is alternatively referred to as a non-battle scene, and the round-based battle scene is alternatively referred to as a battle scene. In the related art, the player-controlled virtual character has health points, and the health points only indicate a health attribute of the player-controlled virtual character in the world scene. When the health points drop to zero, the player-controlled virtual character cannot act on the world map, and needs to go to a specified position to restore health points before continuing to act. However, a health point-related mechanism is typically only associated with activities in the world scene, and only takes effect in the world scene. The related mechanism is monotonous and lacks diversity.

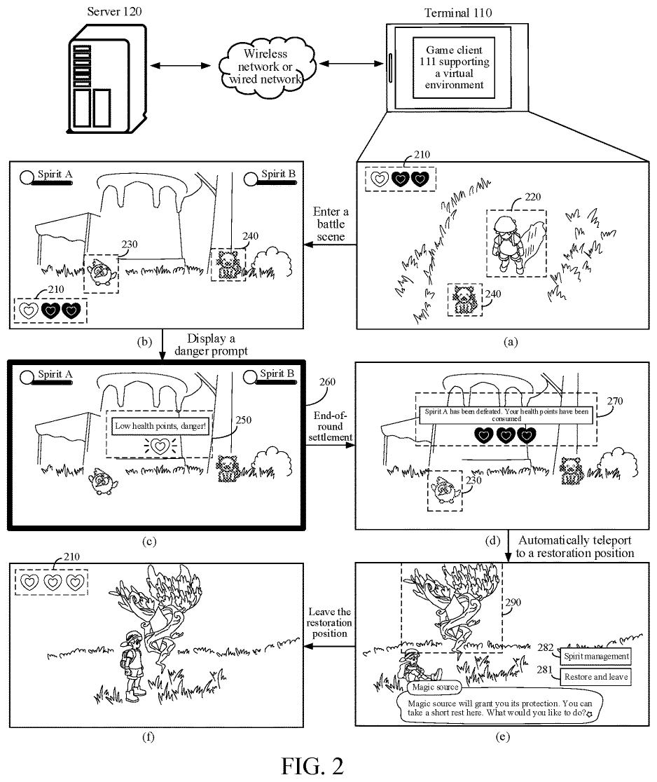

To solve the foregoing problem, this application provides a health point adjustment method. FIG. 2 is a schematic diagram of a health point adjustment method according to an exemplary embodiment of this application. A terminal 110 communicates with a server 120 over a wireless network or a wired network for data exchange. A game client 111 supporting a virtual environment runs on the terminal 110. When the game client 111 supporting the virtual environment is running on the terminal 110, a UI of the game client 111 is displayed on a screen of the terminal 110. In the embodiments of this application, the terms “object”, “user”, “account”, “player”, “virtual character”, “character” and the like have a same meaning, and all represent a virtual avatar controlled in a game. This is not limited in this application.

In a round-based RPG, a player controls a virtual character (a player-controlled virtual character) in the game. The round-based RPG provides two types of maps: a world map and a battle map. The battle map is a part of the world map, or the battle map and the world map are different maps. In a non-battle scene, the player-controlled virtual character can perform activities in the world map, such as walking, running, capturing a pet character, and collecting a virtual prop. In a battle scene, the player-controlled virtual character controls a captured pet character in the battle map, to engage in a round-based battle with an opponent unit, for example, to engage in the round-based battle with a pet character controlled by AI in the game or a pet character captured by another virtual character. In the embodiments of this application, the world scene and the non-battle scene have a same meaning, and the round-based battle scene and the battle scene have a same meaning.

In some embodiments, the terminal displays the player-controlled virtual character located in the world scene and health points of the player-controlled virtual character on the UI.

The health points indicate a health attribute of the player-controlled virtual character in both the world scene and the round-based battle scene. Before the health points drop to zero, the player-controlled virtual character is allowed to perform activities in the world map. When the health points drop to zero, the player-controlled virtual character is not allowed to perform activities in the world map, and needs to replenish health points. For example, the player-controlled virtual character is teleported to a restoration position to replenish health points.

The health points may be referred to as magic points, a health attribute, hit points, a health value, or the like. A specific name of the health points is not limited in the embodiments of this application, and a description is typically made by using the health points as an example.

In some embodiments, the health points include a remaining portion and a consumed portion. The remaining portion is configured for representing current remaining health points, and the consumed portion is configured for representing consumed health points.

Exemplarily, in (a) in FIG. 2, the terminal 110 displays health points 210 of a player-controlled virtual character 220 in a specific area, such as an upper left corner, of the UI, a remaining portion of the health points 210 is represented by a white-filled heart, and a consumed portion of the health points 210 is represented by a black-filled heart. That is, the player-controlled virtual character has a health point upper limit of 3 points, has already consumed 2 health points, and currently holds 1 health point.

In some embodiments, after switching to the round-based battle scene, the terminal displays health points of the player-controlled virtual character in the round-based battle scene based on the health points of the player-controlled virtual character in the world scene.

As shown in (b) in FIG. 2, after the player-controlled virtual character 220 encounters a second pet character 240, a round-based battle is triggered, and switching to the round-based battle scene. The health points 210 of the player-controlled virtual character, a three-dimensional model of a first pet character 230, and a three-dimensional model of the second pet character 240 are displayed in the round-based battle scene. In the embodiments of this application, displaying the three-dimensional model of the first pet character 230 may be referred to as displaying the first pet character 230 for short, and displaying the three-dimensional model of the second pet character 240 may be referred to as displaying the second pet character 240 for short.

In some embodiments, the player-controlled virtual character possesses at least one first pet character.

The first pet character is a pet character that has been successfully captured by the player-controlled virtual character, or a pet character that is encountered by chance and travels along in the world scene. The first pet character may be controlled by a player, or may be controlled by AI, or the player may specify a battle strategy and then the first pet character is controlled by AI based on the battle strategy. This is not limited in this application.

Exemplarily, the player-controlled virtual character 220 possesses a first pet character 230, namely, a spirit A.

In some embodiments, the health points of the player-controlled virtual character after the player-controlled virtual character enters the round-based battle scene are the same as the health points of the player-controlled virtual character before the player-controlled virtual character enters the round-based battle scene.

As shown in (a) and (b) in FIG. 2, the player-controlled virtual character 220 has 1 health point after entering the round-based battle scene, which is the same as the 1 health point before entering the round-based battle scene.

In an embodiment, the health points of the player-controlled virtual character after the player-controlled virtual character enters the round-based battle scene are different from the health points of the player-controlled virtual character before the player-controlled virtual character enters the round-based battle scene.

It is assumed that the player-controlled virtual character 220 has 4 health points before entering the round-based battle scene. Because a health point upper limit is preset to 3 points, the player-controlled virtual character has 3 health points after entering the round-based battle scene.

The health point upper limit in the round-based battle scene may be preset, and may be adjusted to different values based on different types of round-based battle scenes. For example, in a round-based battle scene of a battle with a pet character of a wild type, a health point upper limit is 3 points, and in a round-based battle scene of a battle with another virtual character, a health point upper limit is 4 points.

In some embodiments, during the battle between the first pet character and the second pet character, the terminal displays first prompt information when the health points are less than or equal to a first threshold.

The first threshold is a preset value, for example, is set to 1 health point. When the health points reach a dangerous value, for example, only 1 health point remains, and 1 health point will be deducted upon defeating the first pet character currently on the field, resulting in a loss in a current battle, the terminal displays the first prompt information, to prompt the player that a current situation is dangerous.

In an embodiment, the first prompt information includes at least one of the following: a prompt message, current health points, and a prompt special effect.

As shown in (c) in FIG. 2, the player-controlled virtual character currently has 1 health point. In this case, the terminal 110 displays first prompt information 250, including a prompt message: “Low health points, danger!”, the current 1 health point (1 remaining heart), and a flashing heart prompt special effect.

In some embodiments, the first prompt information further includes an interface special effect. For example, a red flashing special effect is displayed on a UI border 260 (the special effect is represented by a bold border in FIG. 2).

In some embodiments, after the first pet character is defeated, the terminal displays that the health points of the player-controlled virtual character in the round-based battle scene decrease.

As shown in (d) in FIG. 2, after the first pet character 230 (the spirit A) is defeated (a defeated special effect is represented by a dashed line), the terminal 110 displays that the health points of the player-controlled virtual character decrease from 1 point to 0 point (changes from 1 white-filled heart shape and 2 black-filled heart shapes to 3 black-filled heart shapes), and displays second prompt information 270, including a prompt message: “Spirit A has been defeated. Your health points have been consumed”. In the embodiments of this application, the terms “defeated”, “lost in battle”, “fallen in battle”, “dead”, “exhausted”, and the like are all indicate that the pet character cannot continue battling. This is not limited in the embodiments of this application.

In some embodiments, the first pet character includes at least one level, and when the first pet characters of different levels are defeated, different health points are correspondingly reduced.

Exemplarily, the first pet character includes three levels: a primary level, a middle level, and a high level. The primary level may alternatively be referred to as level 1, the middle level may alternatively be referred to as level 2, and the high level may alternatively be referred to as level 3. When the first pet character of the primary level is defeated, 1 health point is correspondingly reduced. When the first pet character of the middle level is defeated, 2 health points are correspondingly reduced. When the first pet character of the high level is defeated, 3 health points are correspondingly reduced. Because the first pet character 230 is at the primary level, 1 health point is reduced after the first pet character is defeated. Reduced health points corresponding to the defeat of the first pet characters of different levels may be preset. The foregoing embodiments are merely used as an example in this embodiment. This is not limited herein.

In some embodiments, when the health points of the player-controlled virtual character decrease to zero, the play-controlled virtual character exits the battle scene and is automatically teleported to a restoration position. The restoration position is configured for restore health points. That is, the terminal controls the player-controlled virtual character to leave the round-based battle scene, and teleports the player-controlled virtual character to the restoration position configured for restoring health points.

As shown in (e) in FIG. 2, a restoration facility, such as a magic source 290, is set at the restoration position. After the player-controlled virtual character interacts with the magic source 290, the terminal 110 displays a dialog box and at least one option control. For example, a dialog box: “Magic source will grant you its protection. You can take a short rest here. What would you like to do?” and a first option control 281 “Restore and leave” and a second option control 282 “Spirit management” are displayed.

In some embodiments, in response to a selection operation for the first option control, the player-controlled virtual character leaves the restoration position and restores health points.

As shown in (f) in FIG. 2, after the player selects the first option control 281 “Restore and leave”, the player-controlled virtual character leaves the restoration position, and health points 210 are restored to 3 points (3 white-filled hearts).

In conclusion, according to the method provided in this embodiment, the health points of the player-controlled virtual character in the round-based battle scene and the health points of the player-controlled virtual character in the world scene are adjusted based on the battle result between the first pet character and the second pet character. This establishes a connection between the health points in the two scenes, and enriches health point-related mechanisms. In this way, the health points not only take effect in the world scene, but also can be applied to the round-based battle scene, to enhance immersive experience of the player. In addition, by introducing the health point mechanism of the player-controlled virtual character in the round-based battle scene, duration of a single battle can be controlled, to mitigate the problem of excessively long duration of the single battle.

According to the method provided in this embodiment, when the health points are less than or equal to the first threshold, the first prompt information is further displayed, to attract the attention of the player to the health points. In this way, the player can formulate a corresponding strategy based on the health points, to mitigate the problem of a battle failure caused by overlooking low health points.

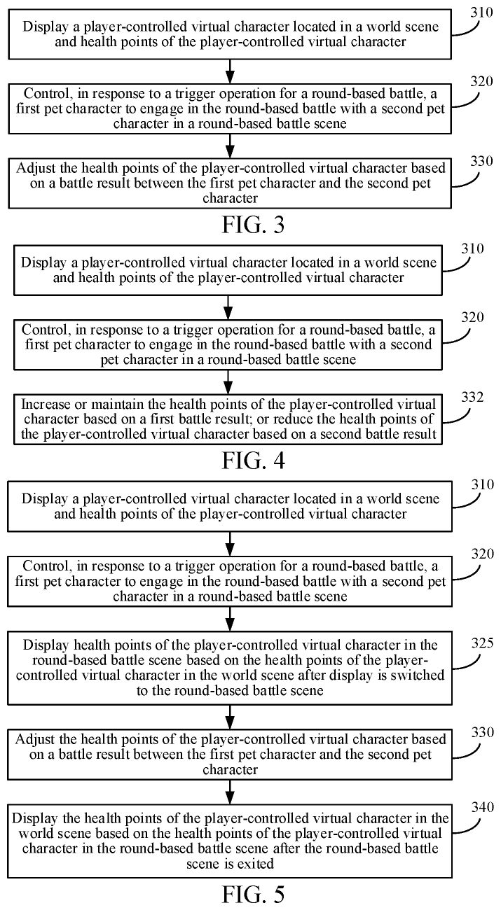

FIG. 3 is a flowchart of a health point adjustment method according to an exemplary embodiment of this application. The method includes at least one of the following operations:

Operation 310: Display a graphical user interface including a player-controlled virtual character located in a world scene and health points of the player-controlled virtual character.

The player-controlled virtual character possesses a first pet character, and the health points indicate a health attribute of the player-controlled virtual character in the world scene and a round-based battle scene.

The world scene is obtained through rendering based on a world map. The world map is a map of a large open virtual world. When the world scene is displayed, one or more tiles on the world map may be displayed. For example, one or more tiles on the world map where the player-controlled virtual character or the first pet character is currently located, as well as some interface elements related to the player-controlled virtual character, a pet character, and the like are displayed.

The round-based battle scene is obtained through rendering based on a battle map. A map area of the battle map is smaller than a map area of the world map. In some embodiments, the battle map is a map independent of the world map and different from the world map. That is, when switching from the world scene to the round-based battle scene, the player-controlled virtual character needs to be teleported from the world map to the battle map. In some embodiments, the battle map is a sub-map based on the world map, such as an area where the player-controlled virtual character is located before switching between the maps. For another example, a small sub-map is selected from the world map based on the area where the player-controlled virtual character is located before switching between the maps, to dynamically generate the battle map. This ensures that the world scene displayed before switching and the round-based battle scene displayed after switching are identical, or have a similarity degree greater than a preset proportion. When the round-based battle scene is displayed, all or some of tiles included in the battle map may be displayed. For example, one or more tiles on the battle map where the player-controlled virtual character or the pet character is currently located, as well as some interface elements related to the player-controlled virtual character, the pet character, and the like are displayed.

Switching between the world scene and the round-based battle scene can be implemented, such as switching from the world scene to the round-based battle scene, or switching from the round-based battle scene to the world scene. In an embodiment, timing for switching between the world scene and the round-based battle scene may be related to a trigger operation of a player, or may be related to battle time of a round-based battle, or may be related to the health points of the player-controlled virtual character. For example, in response to a trigger operation for the round-based battle, switching from the world scene to the round-based battle scene. For another example, when the round-based battle ends, switching from the round-based battle scene to the world scene. For another example, when the health points of the player-controlled virtual character drop to zero, switching from the round-based battle scene to a restoration position in the world scene.

The health points indicate the health attribute of the player-controlled virtual character in the world scene and the round-based battle scene. Before the health points drop to zero, the player-controlled virtual character is allowed to perform activities in the world map, and the player-controlled virtual character may be controlled to perform activities in the world map by triggering a movement joystick. When the health points drop to zero, the player-controlled virtual character is not allowed to perform activities in the world map, the player-controlled virtual character cannot be controlled to perform activities in the world map by triggering the movement joystick, and the player-controlled virtual character needs to replenish health points. For example, the player-controlled virtual character is teleported to the restoration position to replenish health points.

The health points may be referred to as magic points, a health attribute, hit points, a health value, or the like. A specific name of the health points is not limited in the embodiments of this application, and a description is typically made by using the health points as an example.

In some embodiments, the player-controlled virtual character possesses at least one first pet character.

The first pet character is a pet character that has been successfully captured by the player-controlled virtual character, or a pet character that is encountered by chance and travels along in the world scene. The first pet character may be controlled by the player, or may be controlled by AI, or the player may specify a battle strategy and then the first pet character is controlled by AI based on the battle strategy. This is not limited in this application.

The player-controlled virtual character may possess one or more first pet characters, and may select different first pet characters to engage in the battle in the round-based battle scene. In an embodiment, different pet characters may have different battle skills, and the battle skills of the pet characters may be upgraded by picking up virtual props in the world map.

Operation 320: Control, in response to a trigger operation for a round-based battle, a first pet character to engage in the round-based battle with a second pet character in a round-based battle scene.

Before the round-based battle is triggered, the player-controlled virtual character and the second pet character perform activities in the world scene, and after the round-based battle is triggered, the first pet character of the player-controlled virtual character engages in the round-based battle with the second pet character in the round-based battle scene. The first pet character has an autonomous behavior capability, and controlling the first pet character means that an instruction is issued to the first pet character, and the first pet character executes the instruction by using the autonomous behavior capability.

In some embodiments, the trigger operation for the round-based battle includes at least one of the following: attacking the second pet character, being attacked by the second pet character, and throwing a virtual prop to the second pet character.

Through the trigger operation for the round-based battle, switching from the world scene to the round-based battle scene, and the player controls the first pet character to engage in the round-based battle with the second pet character.

In some embodiments, a battle type of the round-based battle includes at least one of a single battle, a double battle, and a team battle. That is, in the round-based battle scene, at least one first pet character of the player-controlled virtual character engage in the round-based battle with at least one second pet character. A battle type of each round may be the same, or may be different. For example, the rounds are single battles. For another example, a first round is a single battle, and a second round is a double battle.

In an embodiment, a quantity of rounds in the round-based battle may be a preset fixed value, or may be any randomly determined value, or may be a dynamic value determined based on attributes of the first pet character and the second pet character. This is not limited in the embodiments of this application.

Exemplarily, an example in which the method is applied to a client on a smartphone having a touchscreen is used, and a round-based battle process includes:
1. Select a first pet character to be sent into battle.
2. Display a round-based battle scene, the round-based battle scene including a skill that the first pet character is allowed to use.
3. Control, in response to a selection operation for a touch control on the touchscreen, the first pet character to cast the skill.
4. Display an animation effect of the skill.
5. A second pet character casts a skill, to complete one round of battle, and repeat operation 2 to operation 5 until health points of one party drop to zero or no pet characters remain available for battle, to end the battle.

The casting the skill in the foregoing embodiments is triggered by tapping the touch control on the touchscreen. The method may further be applied to a client connected to a mouse and a keyboard, or applied to a client connected to a gamepad.

Exemplarily, the casting the skill may be triggered by clicking a button of a mouse, for example, clicking a left button of the mouse to cast the skill. Alternatively, the casting the skill may be triggered by pressing a pre-associated key on the keyboard. For example, a skill 1 to a skill 4 are respectively associated with the number key 1 to the number key 4 on the keyboard, and the skill 1 may be cast by pressing the number key 1. Alternatively, the casting the skill may be triggered by moving a directional joystick on the gamepad and pressing a confirm button. For example, the player moves the directional joystick upward to select a skill in the upward direction, and then presses the confirm button to cast the selected skill. This is not limited in the embodiments of this application.

Operation 330: Adjust the health points of the player-controlled virtual character based on a battle result between the first pet character and the second pet character.

In an embodiment, the health points of the player-controlled virtual character are affected by the battle result of the round-based battle. The battle result between the first pet character and the second pet character is settled when each round ends, and the health points of the player-controlled virtual character are adjusted based on the battle result between the first pet character and the second pet character.

In some embodiments, the battle result between the first pet character and the second pet character includes: a first battle result indicating that the first pet character defeats the second pet character, and a second battle result indicating that the first pet character is defeated by the second pet character.

Regardless of whether the first pet character defeats the second pet character or the first pet character is defeated by the second pet character, the health points of the player-controlled virtual character are adjusted. In addition, when health points of the player-controlled virtual character in the round-based battle scene are adjusted, the health points of the player-controlled virtual character in the world scene are also adjusted. When the health points of the player-controlled virtual character in the world scene are adjusted, the health points of the player-controlled virtual character in the round-based battle scene are also adjusted. The health points in the two scenes are associated with each other.

In conclusion, according to the method provided in this embodiment, the health points of the player-controlled virtual character in the round-based battle scene and the health points of the player-controlled virtual character in the world scene are adjusted based on the battle result between the first pet character and the second pet character. This establishes a connection between the health points in the two scenes, and enriches health point-related mechanisms. In this way, the health points not only take effect in the world scene, but also can be applied to the round-based battle scene, to reduce the sense of disconnection between the world scene and the round-based battle scene, and enhance player experience.

FIG. 4 is a flowchart of a health point adjustment method according to an exemplary embodiment of this application. The method includes at least one of the following operations:

Operation 310: Display a player-controlled virtual character located in a world scene and health points of the player-controlled virtual character.

In some embodiments, the health points includes a remaining portion and a consumed portion. The remaining portion is configured for representing current remaining health points, and the consumed portion is configured for representing consumed health points.

Exemplarily, in (a) in FIG. 2, health points 210 of a player-controlled virtual character 220 are displayed in a specific area, such as an upper left corner, of a UI, a remaining portion of the health points 210 is represented by a white-filled heart, and a consumed portion of the health points 210 is represented by a black-filled heart. That is, the player-controlled virtual character has a health point upper limit of 3 points, has already consumed 2 health points, and currently holds 1 health point.

Operation 320: Control, in response to a trigger operation for a round-based battle, a first pet character to engage in the round-based battle with a second pet character in a round-based battle scene.

In some embodiments, the trigger operation for the round-based battle includes at least one of the following: attacking the second pet character, being attacked by the second pet character, and throwing a virtual prop to the second pet character.

Through the trigger operation for the round-based battle, switching from the world scene to the round-based battle scene, and a player controls the first pet character to engage in the round-based battle with the second pet character.

As shown in (b) in FIG. 2, after the player-controlled virtual character 220 encounters a second pet character 240, a round-based battle is triggered, and switching to the round-based battle scene. The health points 210 of the player-controlled virtual character, a first pet character 230, and the second pet character 240 are displayed in the round-based battle scene. Then, the first pet character 230 engages in the round-based battle with the second pet character 240.

Operation 332: Increase or maintain the health points of the player-controlled virtual character based on a first battle result; or reduce the health points of the player-controlled virtual character based on a second battle result.

The first battle result is a battle result indicating that the first pet character defeats the second pet character, and the second battle result is a battle result indicating that the first pet character is defeated by the second pet character.

In an embodiment, when the first pet character defeats the second pet character, the health points of the player-controlled virtual character are not affected or is positively affected. When the first pet character is defeated by the second pet character, the health points of the player-controlled virtual character is negatively affected.

In an embodiment, a degree to which the health points of the player-controlled virtual character are affected may be related to a type of the second pet character, or a character level of the first pet character, or a character level of the second pet character.

A pet character has corresponding health points, which may alternatively be referred to as hit points, stamina points, a health value, or the like. In the round-based battle, when the health points of the pet character drop to zero, it indicates that the pet character is defeated.

### Association Between Different Types of Second Pet Characters and Health Points:

In some embodiments, the type of the second pet character is a wild type or a captured type. The second pet character of the wild type is a pet character that is not captured, and the second pet character of the captured type is a pet character captured by a virtual character other than the player-controlled virtual character.

The increasing or maintaining the health points of the player-controlled virtual character based on the first battle result includes: keeping the health points of the player-controlled virtual character unchanged based on the first battle result when the type of the second pet character is the wild type; or increasing the health points of the player-controlled virtual character based on the first battle result when the type of the second pet character is the captured type.

In an embodiment, when the first pet character battles against the second pet character of the wild type, even if the second pet character of the wild type is defeated, the health points of the player-controlled virtual character are not changed.

In an embodiment, when the first pet character battles against the second pet character of the captured type, for example, battles against a second pet character of another virtual character, current health points or a health point upper limit of the player-controlled virtual character is increased after the second pet character is defeated.

In some embodiments, the increasing the health points of the player-controlled virtual character based on the first battle result when the type of the second pet character is the captured type includes:
increasing current health points or a health point upper limit of the player-controlled virtual character based on the first battle result when the type of the second pet character is the captured type.

In an embodiment, after the first pet character defeats the second pet character, the current health points of the player-controlled virtual character are increased. For example, before the first pet character defeats the second pet character, the player-controlled virtual character has 1 health point, and after the first pet character defeats the second pet character, the health points of the player-controlled virtual character are increased to 2 points.

Alternatively, after the first pet character defeats the second pet character, the health point upper limit of the player-controlled virtual character is increased. It is assumed that the health point upper limit of the player-controlled virtual character is 3 points. Before the first pet character defeats the second pet character, the player-controlled virtual character has 3 health points, and after the first pet character defeats the second pet character, the health points of the player-controlled virtual character are increased to 4 points, that is, the health point upper limit of the player-controlled virtual character is increased.

Alternatively, after the first pet character defeats the second pet character, available health points of the player-controlled virtual character are increased. It is assumed that the health point upper limit of the player-controlled virtual character is 3 points. Before the first pet character defeats the second pet character, although the health point upper limit is 3 points, the player-controlled virtual character has 2 available health points, and a third health point is locked. That is, an actual health point upper limit is 2 points. After the first pet character defeats the second pet character, the available health points of the player-controlled virtual character are increased to 3 points.

The health points of the player-controlled virtual character in the round-based battle scene and the health points of the player-controlled virtual character in the world scene are adjusted based on the battle result between the first pet character and the second pet character, as well as the types of the pet characters. In this way, the player can formulate a strategy based on the type of the pet character and the current health points, to improve appeal of the game. In addition, when the type of the second pet character is the captured type, the health points of the player-controlled virtual character are increased based on the first battle result. This can improve fault tolerance of the game, and reduce difficulty of the game.

### Association Between Pet Characters of Different Levels and Health Points:

In some embodiments, the first pet character and the second pet character include at least one level. The increasing or maintaining the health points of the player-controlled virtual character based on the first battle result includes:
increasing the health points of the player-controlled virtual character by a j^{th} step size based on the first battle result when a character level of the second pet character is an i^{th} level, i and j being positive integers.

The reducing the health points of the player-controlled virtual character based on the second battle result includes:
reducing the health points of the player-controlled virtual character by a k^{th} step size based on the second battle result when the character level of the first pet character is the i^{th} level, k being a positive integer.

A preset correspondence exists between i and j and a preset correspondence exists between i and k, as shown in Table 1. Exemplarily, when the character level of the second pet character is a primary level, and the first pet character defeats the second pet character, the health points of the player-controlled virtual character are increased by a first step size. When the character level of the first pet character is a high level, and the first pet character is defeated by the second pet character, the health points of the player-controlled virtual character are reduced by a third step size.

TABLE 1

| i | j | k |
|---|---|---|
| 1 (primary level) | 1 | 1 |
| 2 (middle level) | 2 | 2 |
| 3 (high level) | 3 | 3 |

Another preset correspondence may exist between i and j and another preset correspondence may exist between i and k. In the embodiments of this application, a description is made by only using Table 1 as an example. This is not limited herein.

In an embodiment, a degree to which the health points of the player-controlled virtual character are affected may further be related to both the character level of the first pet character and the character level of the second pet character.

In an embodiment, when the character level of the second pet character is the i^{th} level and the character level of the second pet character is not lower than the character level of the first pet character, the health points of the player-controlled virtual character are increased by an m^{th} step size based on the first battle result, where m is greater than j. When the character level of the second pet character is the i^{th} level and the character level of the second pet character is lower than the character level of the first pet character, the health points of the player-controlled virtual character are increased by an n^{th} step size based on the first battle result, where n is less than j.

In an embodiment, when the character level of the first pet character is the i^{th} level and the character level of the second pet character is not lower than the character level of the first pet character, the health points of the player-controlled virtual character are reduced by a p^{th} step size based on the second battle result, where p is less than k. When the character level of the first pet character is the i^{th} level and the character level of the second pet character is lower than the character level of the first pet character, the health points of the player-controlled virtual character are reduced by a q^{th} step size based on the second battle result, where q is greater than k.

The health points of the player-controlled virtual character in the round-based battle scene and the health points of the player-controlled virtual character in the world scene are adjusted based on the battle result between the first pet character and the second pet character, as well as the levels of the pet characters. In this way, the player can formulate a strategy based on the levels of the pet characters and the current health points, to improve appeal of the game. In addition, according to different levels of the pet characters, the health points are correspondingly increased or reduced. In this way, duration of a single battle can be controlled. For example, it is assumed that pet characters of all levels correspond to a health point change of 1 point, the player-controlled virtual character has 3 health points in the round-based battle scene, the player-controlled virtual character carries one first pet character of the high level and five first pet characters of the low level, and the current battle ends when three first pet characters are defeated. However, in this method, because a change in the health points is related to the levels of the pet characters, the current battles ends when only one first pet character of the high level is defeated. In this way, the problem of excessively long duration of a single battle is solved to some extent.

In conclusion, according to the method provided in this embodiment, the health points of the player-controlled virtual character in the round-based battle scene and the health points of the player-controlled virtual character in the world scene are adjusted based on the battle result between the first pet character and the second pet character, as well as the types and/or levels of the pet characters. In this way, the player can formulate a strategy based on the type and/or the levels of the pet characters and the current health points, to improve appeal of the game.

FIG. 5 is a flowchart of a health point adjustment method according to an exemplary embodiment of this application. The method includes at least one of the following operations:

Operation 310: Display a player-controlled virtual character located in a world scene and health points of the player-controlled virtual character.

Operation 320: Control, in response to a trigger operation for a round-based battle, a first pet character to engage in the round-based battle with a second pet character in a round-based battle scene.

Operation 325: Display health points of the player-controlled virtual character in the round-based battle scene based on the health points of the player-controlled virtual character in the world scene after switching to the round-based battle scene.

In some embodiments, when the player-controlled virtual character has neither a positive buff state nor a negative buff state before switching to the round-based battle scene, it is displayed that the health points of the player-controlled virtual character in the round-based battle scene are the same as the health points of the player-controlled virtual character in the world scene after switching to the round-based battle scene.

When the player-controlled virtual character has neither the positive buff state nor the negative buff state, the health points in the round-based battle scene carry over from the health points in the world scene, that is, the health points in the two scenes are the same.

### Negative Buff State-Associated Mechanism for Continuously Reducing Health Points:

In some embodiments, when the player-controlled virtual character has the negative buff state before switching to the round-based battle scene, it is displayed that the health points of the player-controlled virtual character in the round-based battle scene and health points of the first pet character continuously decrease within second duration after switching to the round-based battle scene. The negative buff state is a state in which a battle capability of the first pet character is reduced.

By way of example and not limitation, the negative buff state includes at least one of the following: poisoned, burned, frozen, confused, infected, bound, and bleeding.

In some embodiments, the negative buff state of the player-controlled virtual character is obtained based on the world scene, or is obtained based on the first pet character.

For example, when entering a world scene with a snowy mountain environment, the player-controlled virtual character obtains a frozen negative buff state. Alternatively, when the first pet character obtains a burned negative buff state in the round-based battle scene, the player-controlled virtual character obtains the burned negative buff state after switching to the world scene.

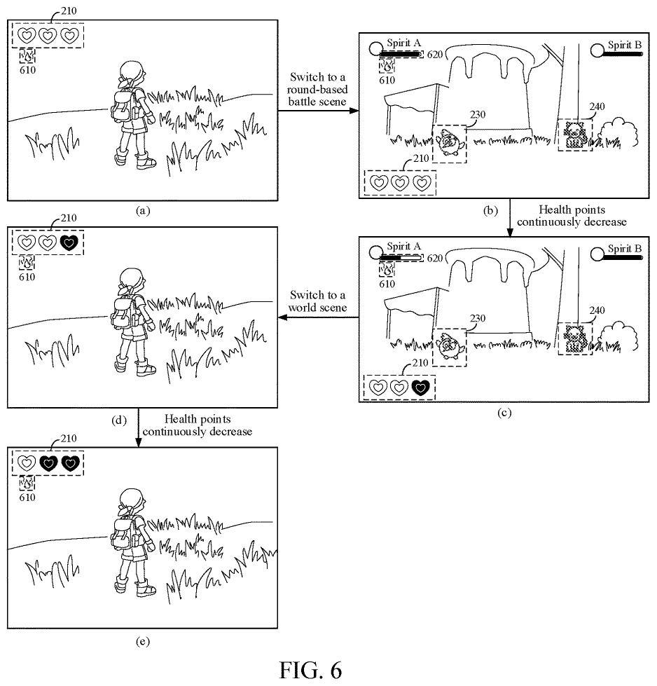

As shown in (a) in FIG. 6, before switching to the round-based battle scene, the player-controlled virtual character has a burned negative buff state 610, and the burned negative buff state 610 is represented by a burning flame icon, and may be displayed below health points 210 of the player-controlled virtual character. In this case, the player-controlled virtual character has 3 health points 210.

After switching to the round-based battle scene, as shown in (B) in FIG. 6, a terminal displays a spirit A (the first pet character) 230, a spirit B (the second pet character) 240, health points 620 of the spirit A, the burned negative buff state 610, and the health points 210 of the player-controlled virtual character. In this case, the player-controlled virtual character has 3 health points 210.

After a period of time, for example, after one round, the terminal displays that both the health points 210 of the player-controlled virtual character and the health points 620 of the spirit A are reduced. As shown in (c) in FIG. 6, the health points 210 of the player-controlled virtual character are reduced to 2 points, and the health points 620 of the spirit A are reduced by half. In this case, the spirit A defeats the spirit B, and the battle ends.

In some embodiments, the second duration includes at least one of the following: a quantity of rounds in the round-based battle scene and actual time in the world scene.

Exemplarily, the second duration is 5 rounds in the round-based battle scene, or 30 seconds in the world scene.

In an embodiment, a preset correspondence exists between the quantity of rounds and the actual time. For example, 1 round in the round-based battle scene is equal to 6 seconds in the world scene.

Exemplarily, when the second duration is 30 seconds in the world scene, it is assumed that the player-controlled virtual character has already had the negative buff state for 18 seconds in the world scene, if switching to the round-based battle scene at this moment, the remaining second duration is (30−18)/6=2 rounds.

In some embodiments, the second duration is affected by at least one of the following factors: a factor in the world scene, a level of the player-controlled virtual character, and a quantity of first pet characters carried by the player-controlled virtual character.

For example, when the world scene is in rainy weather, second duration corresponding to the burned negative buff state is reduced by half, and second duration corresponding to the frozen negative buff state is doubled. Alternatively, second duration corresponding to the player-controlled virtual character of level 1 is twice second duration corresponding to the player-controlled virtual character of level 10. Alternatively, when the player-controlled virtual character carries six first pet characters, corresponding second duration is 10 seconds, and when the player-controlled virtual character carries three first pet characters, corresponding second duration is 20 seconds. The factor affecting the second duration is not limited in this application, and a description is made by only using the foregoing factors as an example.

The negative buff state of the player-controlled virtual character before switching to the round-based battle scene is associated with the health points of the player-controlled virtual character after switching to the round-based battle scene. In this way, the health points of the player-controlled virtual character after switching to the round-based battle scene are still affected by the negative buff state, and health point-related gameplay mechanisms are further enriched.

### Positive Buff State-Associated Mechanism for Continuously Increasing Health Points:

In some embodiments, when the player-controlled virtual character has a positive buff state before switching to the round-based battle scene, it is displayed that the health points of the player-controlled virtual character in the round-based battle scene and the health points of the first pet character continuously increase within fourth duration after switching to the round-based battle scene. The positive buff state is a state in which the battle capability of the first pet character is enhanced.

By way of example and not limitation, the positive buff state includes at least one of the following: gradual healing, encouragement, assistance, eating, and idling.

In some embodiments, the positive buff state of the player-controlled virtual character is obtained based on the world scene, or is obtained based on the first pet character.

For example, after eating meal in the world scene, the player-controlled virtual character obtains an eating positive buff state. Alternatively, the first pet character obtains a gradual healing positive buff state in the round-based battle scene, the player-controlled virtual character obtains the gradual healing positive buff state after switching to the world scene.

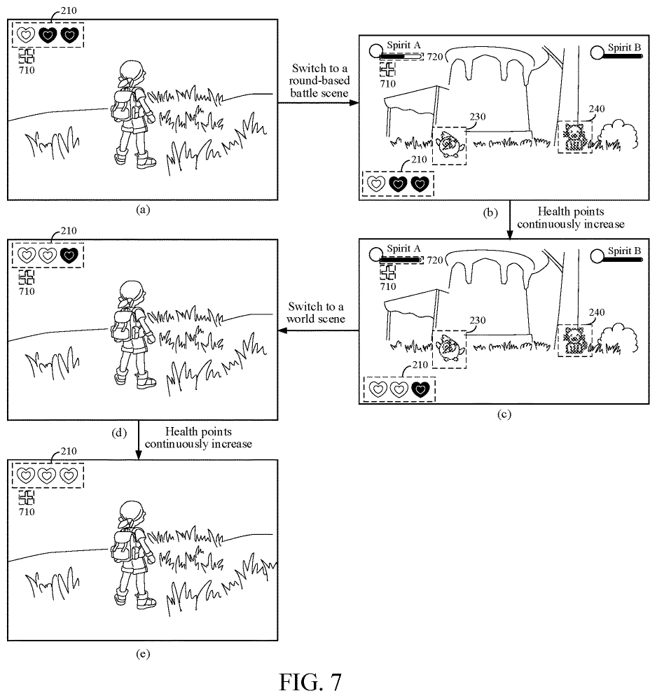

As shown in (a) in FIG. 7, before switching to the round-based battle scene, the player-controlled virtual character has a gradual healing positive buff state 710, and the gradual healing positive buff state 710 is represented by a cross icon, and may be displayed below health points 210 of the player-controlled virtual character. In this case, the player-controlled virtual character has 1 health point 210.

After switching to the round-based battle scene, as shown in (B) in FIG. 7, a terminal displays a spirit A (the first pet character) 230, a spirit B (the second pet character) 240, health points 720 of the spirit A, a gradual healing positive buff state 710, and the health points 210 of the player-controlled virtual character. In this case, the player-controlled virtual character has 1 health point 210.

After a period of time, for example, after one round, the terminal displays that both the health points 210 of the player-controlled virtual character and the health points 720 of the spirit A are increased. As shown in (c) in FIG. 7, the health points 210 of the player-controlled virtual character are increased to 2 points, and the health points 720 of the spirit A are completely restored. In this case, the spirit A defeats the spirit B, and the battle ends.

In some embodiments, the fourth duration includes at least one of the following: a quantity of rounds in the round-based battle scene and actual time in the world scene.

Exemplarily, the fourth duration is 5 rounds in the round-based battle scene, or 30 seconds in the world scene.

In an embodiment, a preset correspondence exists between the quantity of rounds and the actual time. For example, 1 round in the round-based battle scene is equal to 6 seconds in the world scene.

Exemplarily, when the fourth duration is 30 seconds in the world scene, it is assumed that the player-controlled virtual character has already carried the positive buff state for 18 seconds in the world scene, if switching to the round-based battle scene at this moment, the remaining fourth duration is (30−18)/6=2 rounds.

In some embodiments, the fourth duration is affected by at least one of the following factors: a factor in the world scene, a level of the player-controlled virtual character, and a quantity of first pet characters carried by the player-controlled virtual character.

For example, when the player-controlled virtual character is in a restaurant, fourth duration corresponding to the eating positive buff state is doubled. Alternatively, fourth duration corresponding to the player-controlled virtual character of level 10 is twice fourth duration corresponding to the player-controlled virtual character of level 1. Alternatively, when the player-controlled virtual character carries six first pet characters, corresponding fourth duration is 20 seconds, and when the player-controlled virtual character carries three first pet characters, corresponding fourth duration is 10 seconds. The factor affecting the fourth duration is not limited in this application, and a description is made by only using the foregoing factors as an example.

The positive buff state of the player-controlled virtual character before switching to the round-based battle scene is associated with the health points of the player-controlled virtual character after switching to the round-based battle scene. In this way, the health points of the player-controlled virtual character after switching to the round-based battle scene are still affected by the positive buff state, and health point-related gameplay mechanisms are further enriched.

### Health Point Upper Limit Mechanism in a Round-Based Battle Scene:

In some embodiments, the round-based battle scene corresponds to a health point upper limit, and the health points of the player-controlled virtual character in the world scene are a first value.

After switching to the round-based battle scene, when the first value is less than the health point upper limit, the health points of the player-controlled virtual character in the round-based battle scene are displayed as the first value based on the health points of the player-controlled virtual character in the world scene; or
after switching to the round-based battle scene, when the first value is greater than the health point upper limit, the health points of the player-controlled virtual character in the round-based battle scene are displayed as a second value based on the health points of the player-controlled virtual character in the world scene, where the second value is a value corresponding to the health point upper limit.

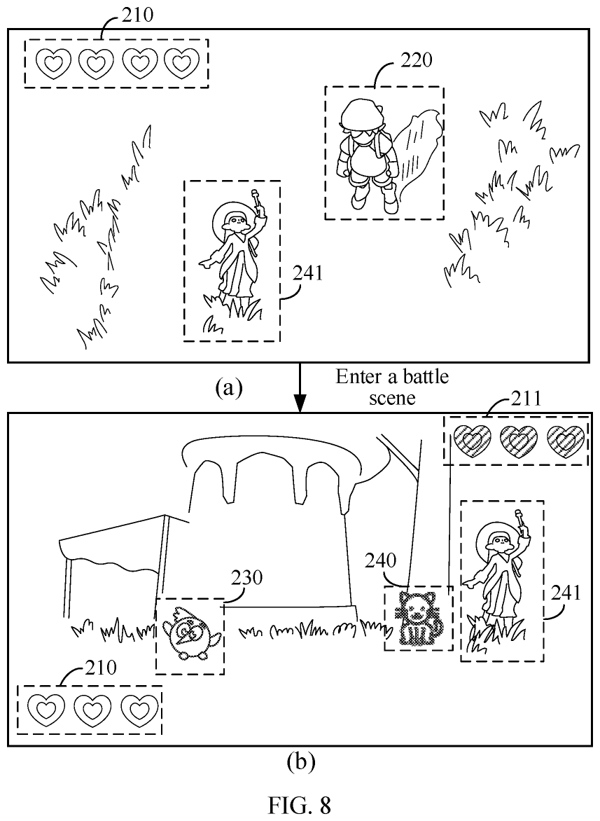

As shown in (a) in FIG. 8, a player-controlled virtual character 220 has 4 health points in the world scene, after the player-controlled virtual character 220 interacts with an opponent virtual character 241, a round-based battle is triggered, and a health point upper limit corresponding to the round-based battle scene is 3 points.

As shown in (b) in FIG. 8, after switching to the round-based battle scene, a first pet character 230, a second pet character 240, health points 210 of the player-controlled virtual character, the opponent virtual character 241, and health points 211 of the opponent virtual character are displayed. The health points 210 of the player-controlled virtual character are represented by a white-filled heart, and the health points 211 of the opponent virtual character are represented by a shadow-filled heart.

Because the player-controlled virtual character 220 has 4 health points in the world scene, which are greater than the health point upper limit of 3 points, 3 health points 210 of the player-controlled virtual character are displayed in the round-based battle scene.

In some embodiments, different round-based battle scenes correspond to different health point upper limits.

The health point upper limits corresponding to different round-based battle scenes may be preset values. For example, a health point upper limit corresponding to a round-based battle scene with a wild environment is 3 points, and a health point upper limit corresponding to a round-based battle scene with an urban environment is 5 points.

By setting the health point upper limit corresponding to the round-based battle scene, a case that excessively high health points of the player-controlled virtual character that are carried over from the world scene into the round-based battle scene affects duration of a single battle is avoided, and the problem of excessively long duration of the single battle is solved.

Operation 330: Adjust the health points of the player-controlled virtual character based on a battle result between the first pet character and the second pet character.

Operation 340: Display the health points of the player-controlled virtual character in the world scene based on the health points of the player-controlled virtual character in the round-based battle scene after exiting the round-based battle scene.

In some embodiments, when the first pet character has neither a positive buff state nor a negative buff state, it is displayed that the health points of the player-controlled virtual character in the world scene are the same as the health points of the player-controlled virtual character in the round-based battle scene after exiting the round-based battle scene.

When the first pet character has neither the positive buff state nor the negative buff state, the health points of the player-controlled virtual character in the world scene carry over from the health points in the round-based battle scene, that is, the health points in the two scenes are the same.

### Negative Buff State-Associated Mechanism for Continuously Reducing Health Points:

In some embodiments, when the first pet character has the negative buff state after exiting the round-based battle scene, it is displayed that the health points of the player-controlled virtual character in the world scene continuously decrease within first duration. The negative buff state is a state in which a battle capability of the first pet character is reduced.

After exiting the round-based battle scene, switching to the world scene. As shown in (d) in FIG. 6, health points 210 of the player-controlled virtual character and a burned negative buff state 610 are displayed. The player-controlled virtual character has 2 health points 210, which are the same as health points 210 of the player-controlled virtual character in the round-based battle scene when a spirit A defeats a spirit B.

When the negative buff state is not removed, it is displayed that the health points of the player-controlled virtual character in the world scene continuously decrease. As shown in (e) in FIG. 6, when the burned negative buff state 610 is not removed, it is displayed that the health points 210 of the player-controlled virtual character continuously decrease from 2 points to 1 point.

For content related to the first duration, refer to the description related to the second duration in operation 325. Details are not described herein again. In an embodiment, the first duration and the second duration may be the same, or may be different. This is not limited in the embodiments of this application.

The negative buff state of the first pet character in the round-based battle scene is associated with the health points of the player-controlled virtual character after switching to the world scene. In this way, the health points of the player-controlled virtual character after switching to the world scene are still affected by the negative buff state, and health point-related gameplay mechanisms are further enriched.

### Positive Buff State-Associated Mechanism for Continuously Increasing Health Points:

In some embodiments, when the first pet character has a positive buff state, it is displayed that the health points of the player-controlled virtual character in the world scene continuously increase within third duration after exiting the round-based battle scene. The positive buff state is a state in which the battle capability of the first pet character is enhanced.

After exiting the round-based battle scene, switching to the world scene. As shown in (d) in FIG. 7, health points 210 of the player-controlled virtual character and a gradual healing positive buff state 710 are displayed. The player-controlled virtual character has 2 health points 210, which are the same as health points 210 of the player-controlled virtual character in the round-based battle scene when a spirit A defeats a spirit B.

When the positive buff state is not removed, it is displayed that the health points of the player-controlled virtual character in the world scene continuously increase. As shown in (e) in FIG. 7, when the gradual healing positive buff state 710 is not removed, it is displayed that the health points 210 of the player-controlled virtual character continuously increase from 2 points to 3 points.

For content related to the third duration, refer to the description related to the fourth duration in operation 325. Details are not described herein again. In an embodiment, the third duration and the fourth duration may be the same, or may be different. This is not limited in the embodiments of this application.

The positive buff state of the first pet character in the round-based battle scene is associated with the health points of the player-controlled virtual character after switching to the world scene. In this way, the health points of the player-controlled virtual character after switching to the world scene are still affected by the positive buff state, and health point-related gameplay mechanisms are further enriched.

In conclusion, according to the method provided in this embodiment, by introducing the negative buff state-associated mechanism for continuously reducing the health points and the positive buff state-associated mechanism for continuously increasing the health points, an association is established between the negative buff states (or the positive buff states) in the world scene and the round-based battle scene. In this way, the negative buff state (or the positive buff state) in the world scene can affect the round-based battle scene, or the negative buff state (or the positive buff state) in the round-based battle scene can also affect the world scene. This enhances the association between the two scenes, improves consistency and connectivity between the two scenes, and enriches health point-related mechanisms to a larger extent, reduces the sense of disconnection between the world scene and the round-based battle scene, and improves player experience.

According to the method provided in this embodiment, by further setting the health point upper limit corresponding to the round-based battle scene, a case that excessively high health points of the player-controlled virtual character that are carried over from the world scene into the round-based battle scene affects duration of a single battle is avoided, and the problem of excessively long duration of the single battle is solved.

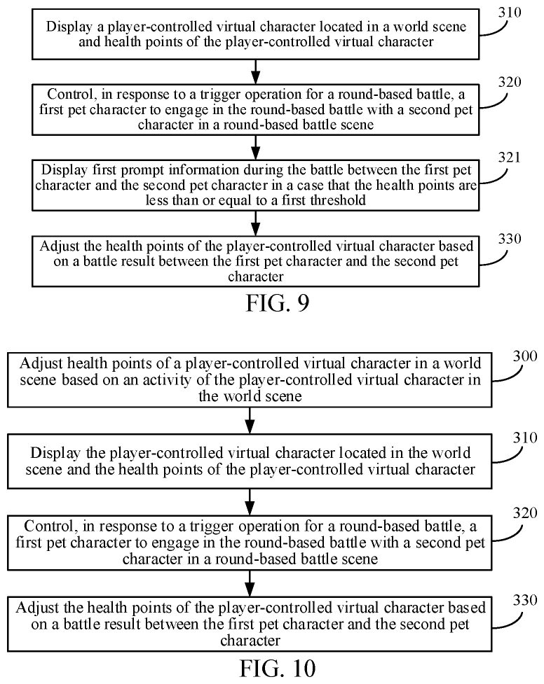

FIG. 9 is a flowchart of a health point adjustment method according to an exemplary embodiment of this application. Compared with the embodiment in FIG. 3, the method further includes operation 321.

Operation 321: Display first prompt information during the battle between the first pet character and the second pet character when the health points are less than or equal to a first threshold.

The first threshold is a preset value, for example, is set to 1 health point. When the health points reach a dangerous value, for example, only 1 health point remains, and 1 health point will be deducted upon defeating the first pet character currently on the field, resulting in a loss in a current battle, a terminal displays the first prompt information, to prompt a player that a current situation is dangerous.

In an embodiment, the first prompt information includes at least one of the following: a prompt message, current health points, and a prompt special effect.

As shown in (c) in FIG. 2, the player-controlled virtual character currently has 1 health point. In this case, first prompt information 250 is displayed, including a prompt message: “Low health points, danger!”, the current 1 health point (1 remaining heart), and a flashing heart prompt special effect.

In some embodiments, the first prompt information further includes an interface special effect. For example, a red flashing special effect is displayed on a UI border 260 (the special effect is represented by a bold border in FIG. 2).

In conclusion, according to the method provided in this embodiment, the first prompt information is displayed when the health points are less than or equal to the first threshold, to attract attention of the player to the health points. In this way, the player can formulate a corresponding strategy based on the health points, to mitigate the problem of a battle failure caused by overlooking low health points.

FIG. 10 is a flowchart of a health point adjustment method according to an exemplary embodiment of this application. Compared with the embodiment in FIG. 3, the method further includes operation 300. Operation 300 may be alternatively performed after another operation, for example, after operation 330. This embodiment is described by only using an example in which operation 300 is performed before operation 310. This is not limited herein.

Operation 300: Adjust the health points of the player-controlled virtual character in the world scene based on an activity of the player-controlled virtual character in the world scene.

In some embodiments, the health points includes a remaining portion and a consumed portion. The remaining portion is configured for representing current remaining health points, and the consumed portion is configured for representing consumed health points.

Adjusting the health points of the player-controlled virtual character in the world scene is increasing or reducing the remaining portion and correspondingly reducing or increasing the consumed portion.

As shown in (a) in FIG. 2, health points 210 of a player-controlled virtual character 220 are displayed in a specific area, such as an upper left corner, of a UI, a remaining portion of the health points 210 is represented by a white-filled heart, and a consumed portion of the health points 210 is represented by a black-filled heart. That is, the player-controlled virtual character has a health point upper limit of 3 points, has already consumed 2 health points, and currently holds 1 health point.

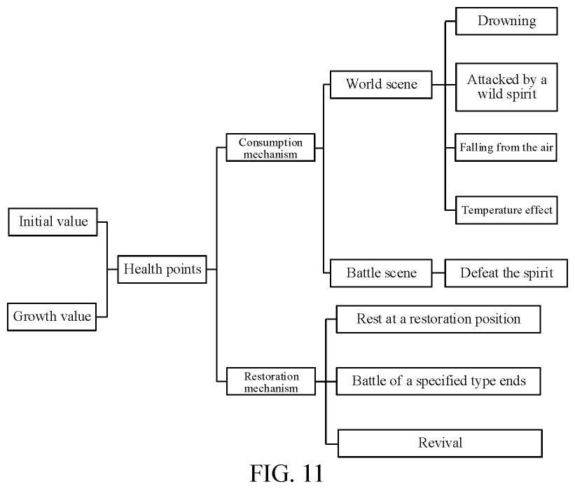

FIG. 11 is a schematic diagram of a health point-related mechanism according to an exemplary embodiment of this application.

Health points has an initial value and a growth value. For example, the initial value is 3 health points, and the growth value is associated with a specified virtual prop, a level of a player-controlled virtual character, or the like.

In some embodiments, a health point upper limit is increased by using the specified virtual prop.

Exemplarily, the health point upper limit of the life value is increased by using a health potion. The health point upper limit is increased by 1 point by using one health potion, and the health point upper limit is increased by 5 points at most.

In some embodiments, the health point-related mechanism includes a consumption mechanism and a restoration mechanism. The consumption mechanism is a mechanism related to a health point consumption manner, and the restoration mechanism is a mechanism related to a health point restoration manner.

In some embodiments, the health point restoration mechanism includes at least one of the following: a mechanism related to resting at a restoration position, a mechanism related to ending of a battle of a specified type, and a revival mechanism.

For the mechanism related to resting at the restoration position, in (e) in FIG. 2, a restoration facility, such as a magic source 290, is set at the restoration position. After the player-controlled virtual character interacts with the magic source 290, a dialog box and at least one option control are displayed. For example, a dialog box: “Magic source will grant you its protection. You can take a short rest here. What would you like to do?” and a first option control 281 “Restore and leave” and a second option control 282 “Spirit management” are displayed. After a player selects the first option control 281 “Restore and leave”, the player-controlled virtual character leaves the restoration position and the health points 210 are restored to 3 points (3 white-filled hearts), that is, the health points are restored to the upper limit.

For the mechanism related to ending of the battle of the specified type, after a battle with a pet character of a specified type ends, the health points of the player-controlled virtual character are restored. For example, after a battle with a pet character of a regional boss type ends, the health points of the player-controlled virtual character are completely restored.

For the revival mechanism, the health points drop to zero due to reasons such as drowning, falling from the air, and an ambient temperature effect, and the player-controlled virtual character is automatically teleported to the restoration position for revival, that is, the health points are completely restored.

In some embodiments, the health point consumption mechanism includes a consumption mechanism in the battle scene and a consumption mechanism in the world scene.

The consumption mechanism in the battle scene means that: if the first pet character (the spirit) of the player-controlled virtual character is defeated, the health points of the player-controlled virtual character are reduced. For specific implementation details, refer to the embodiments in FIG. 2 to FIG. 9. Details are not described herein again.

The consumption mechanism in the world scene includes at least one of the following: a drowning-related mechanism, a mechanism related to being attacked by a pet character of a wild type (a wild spirit), a mechanism related to falling from the air, and a mechanism related to a temperature effect. For specific implementation details, refer to the following description.

### Drowning-Related Mechanism:

In some embodiments, when the player-controlled virtual character is drowning in a water environment, the remaining portion is reduced, and the consumed portion is increased.

In an embodiment, the player-controlled virtual character has stamina points, and the stamina points are configured for limiting endurance of activities of the player-controlled virtual character on the world map.

Exemplarily, the activity related to the stamina points includes at least one of the following: swimming, running, climbing, gliding, and diving.

When the stamina points drop to zero, all of the foregoing activities are stopped, the player-controlled virtual character that is swimming or diving is drowning, the player-controlled virtual character that is running is starting to walk, and the player-controlled virtual character that is climbing and gliding is falling downward.

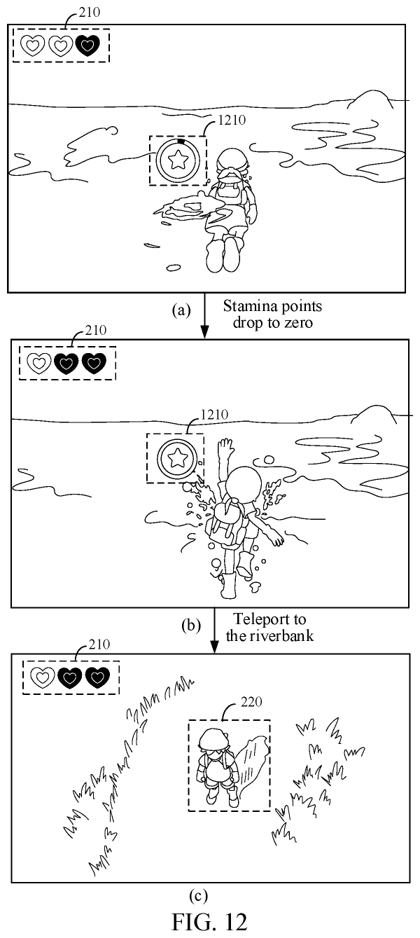

As shown in (a) in FIG. 12, a player-controlled virtual character is swimming in a river, and a stamina bar 1210 is displayed around the player-controlled virtual character. The stamina bar 1210 is ring-shaped, and a black part represents remaining stamina points. In (a) in FIG. 12, some stamina points remain. In this case, 2 health points 210 remain.

In (b) in FIG. 12, a stamina bar 1210 shows that the stamina points drop to zero. In this case, the player-controlled virtual character is drowning, the health points are reduced by 1 point, namely, 1 health point remains.

In (c) in FIG. 12, because the health points of the player-controlled virtual character do not drop to zero, the player-controlled virtual character is teleported to a riverbank position before entering the river, namely, a walkable position recorded by a system, and 1 health point 210 is displayed. It is assumed that the health points of the player-controlled virtual character drop to zero, the player-controlled virtual character is teleported to the restoration position for revival.

Mechanism Related to being Attacked by a Pet Character of a Wild Type (Wild Spirit):

In some embodiments, when the player-controlled virtual character is attacked by the pet character of the wild type, the remaining portion is reduced, and the consumed portion is increased. The pet character of the wild type is a pet character that is not captured.

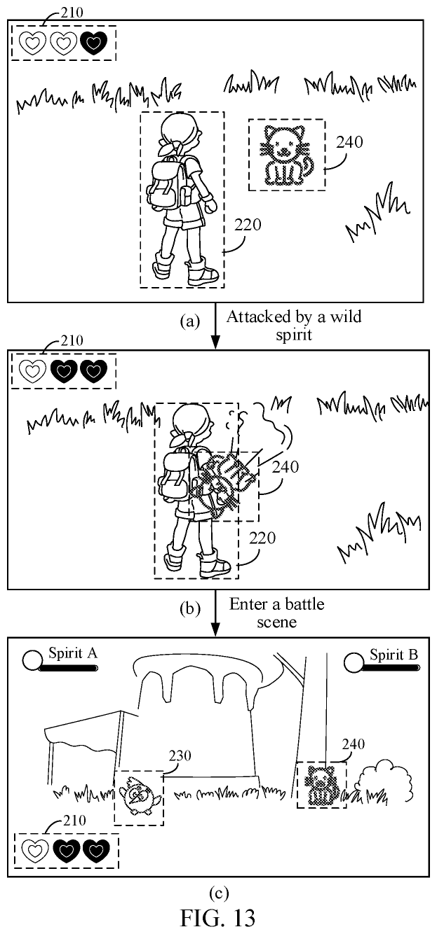

Exemplarily, in (a) in FIG. 13, a player-controlled virtual character 220 encounters with a second pet character 240, the second pet character 240 is a pet character of the wild type, and the two parties do not interact with each other. In this case, the remaining portion of the health points 210 is 2 points.

In (b) in FIG. 13, the second pet character 240 actively launches an attack on the player-controlled virtual character 220, to trigger a round-based battle. In this case, the remaining portion of the health points 210 is reduced to 1 point.

In (c) in FIG. 13, the player-controlled virtual character and the second pet character enter a battle scene. The health points 210 of the player-controlled virtual character, a first pet character 230 (a spirit A), and the second pet character 240 (a spirit B) are displayed in the battle scene. In this case, the remaining portion of the health points 210 is 1 point.

Mechanism Related to Falling from the Air:

In some embodiments, when the player-controlled virtual character falls from the air to the ground, the remaining portion is reduced, and the consumed portion is increased.

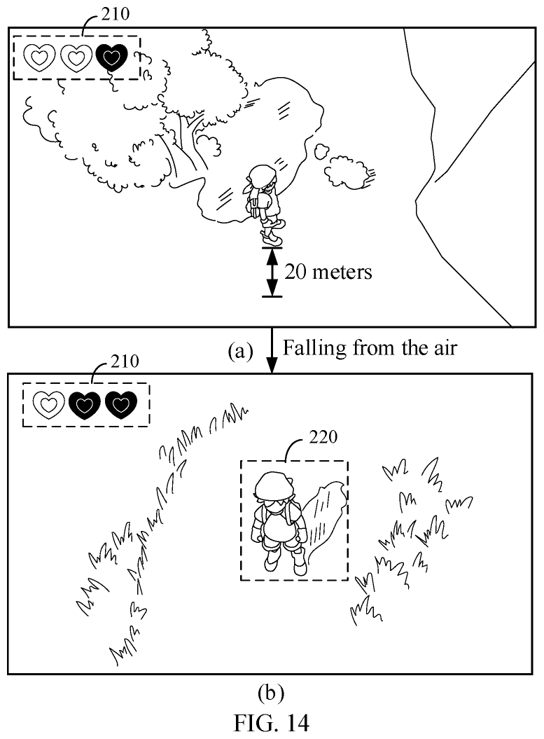

As shown in (a) in FIG. 14, when the player-controlled virtual character is located in the air 20 meters away from the ground, the remaining portion of the health points 210 is 2 points, and the consumed portion is 1 point.

When the player-controlled virtual character falls to the ground from the air 20 meters away from the ground, the remaining portion is reduced, and the consumed portion is increased. As shown in (b) in FIG. 14, the remaining portion of the health point 210 is 1 point, and the consumed portion is 2 points.

In some embodiments, a reduction step size of the remaining portion and an increase step size of the consumed portion are related to a distance between the player-controlled virtual character and the ground.

Exemplarily, a larger distance between the player-controlled virtual character and the ground indicates a larger step size of the reduction and a larger step size of the increase. When the player-controlled virtual character falls to the ground from the air 0 to 10 meters away from the ground, the health points are reduced by 0 point, that is, the reduction step size and the increase step size are 0. When the player-controlled virtual character falls to the ground from the air 10 to 30 meters away from the ground, the health points are reduced by 1 point, that is, the reduction step size and the increase step size are 1. When the player-controlled virtual character falls to the ground from the air 30 to 50 meters away from the ground, the health points are reduced by 2 points, that is, the reduction step size and the increase step size are 2. When the player-controlled virtual character falls to the ground from the air more than 50 meters away from the ground, all the health points are reduced, that is, the reduction step size and the increase step size correspond to all the health points.

In some embodiments, when the ground is a water environment or a ground of another buffering type, the remaining portion and the consumed portion remain unchanged.

For example, the player-controlled virtual character falls from the air into a river, and the health points remain unchanged. Alternatively, the player-controlled virtual character falls from the air to a haystack, and the health points remain unchanged.

In some embodiments, when the player-controlled virtual character falls from the air to the ground while riding a pet character of a first type, the remaining portion is reduced, and the consumed portion is increased. When the player-controlled virtual character falls from the air to the ground while riding a pet character of a second type, the health points remain unchanged.

The pet character of the firs type does not have a flying capability, and the pet character of the second type has a flying capability.

Exemplarily, when the player-controlled virtual character falls from the air to the ground while riding a white wolf, the health points is reduced by 1 point. When the player-controlled virtual character falls from the air to the ground while riding a black eagle, the health points remain unchanged.

### Mechanism Related to a Temperature Effect:

In some embodiments, when player-controlled virtual character is affected by an ambient temperature, the remaining portion is reduced, and the consumed portion is increased.

The ambient temperature is determined based on a position of the player-controlled virtual character or a virtual prop around the player-controlled virtual character. For example, the player-controlled virtual character is located in a desert environment, and the ambient temperature is high. Alternatively, a virtual campfire is present near the player-controlled virtual character, and the ambient temperature is high. Alternatively, the player-controlled virtual character is located in a snowy mountain environment, and the ambient temperature is low.

In some embodiments, when the player-controlled virtual character is located in an environment above a first temperature threshold, the remaining portion is reduced, and the consumed portion is increased.

In an embodiment, when duration of the player-controlled virtual character being located in the environment above the first temperature threshold is shorter than first effect duration, a first temperature special effect is added to the remaining portion.

When the duration of the player-controlled virtual character being located in the environment above the first temperature threshold is longer than the first effect duration, a second temperature special effect is added to the remaining portion, the remaining portion is reduced, and the consumed portion is increased.

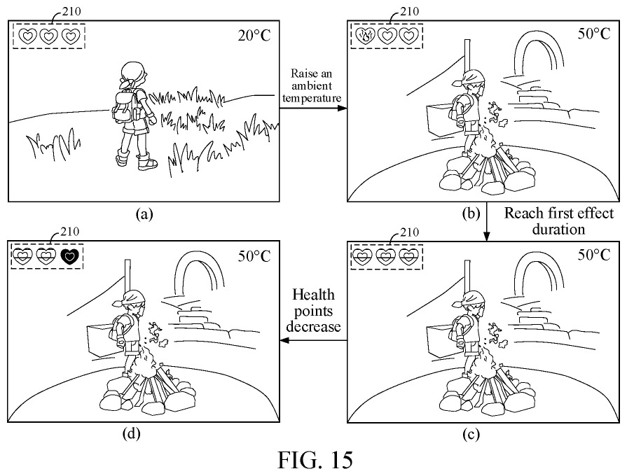

Exemplarily, the first temperature threshold is a preset value, for example, is set to 40 degrees Celsius. As shown in (a) in FIG. 15, the player-controlled virtual character is located in an environment below the first temperature threshold, a current temperature is 20 degrees Celsius, and health points 210 remain unchanged.

As shown in (b) in FIG. 15, the player-controlled virtual character is close to a virtual campfire. Because of existence of the virtual campfire, the ambient temperature is 50 degrees Celsius, which is above the first temperature threshold. It is assumed that the first effect duration is 20 seconds. When duration of the player-controlled virtual character being located in an environment of 50 degrees Celsius is shorter than 20 seconds, the first temperature special effect, such as a flames mask special effect, is added to the remaining portion of the health points 210. As the duration of the player-controlled virtual character being located in the environment of 50 degrees Celsius gradually increases, the remaining portion of the health points 210 that is covered by the first temperature special effect gradually increases, until the duration of the player-controlled virtual character being located in the environment of 50 degrees Celsius is equal to 20 seconds, the first temperature special effect completely covers the remaining portion of the health points 210.

When the duration of the player-controlled virtual character being located in the environment of 50 degrees Celsius is longer than 20 seconds, a second temperature special effect, such as an orange special effect, is added to the entire remaining portion of the health points 210. As shown in (c) in FIG. 15, the orange special effect is represented by filling with horizontal line hatching. In addition, as the duration of the player-controlled virtual character being located in the environment of 50 degrees Celsius gradually increases, the remaining portion of the health points 210 decreases, and the consumed portion increases. As shown in (d) in FIG. 15, the health points 210 decrease from 3 points to 2 points. If the player-controlled virtual character continues to be located in the environment of 50 degrees Celsius, the health points continue to decrease until the health points drop to zero.

In some embodiments, when the player-controlled virtual character is located in an environment below a second temperature threshold, the remaining portion is reduced, and the consumed portion is increased.

In an embodiment, when duration of the player-controlled virtual character being located in the environment below the second temperature threshold is shorter than the first effect duration, a third temperature special effect is added to the remaining portion.

When the duration of the player-controlled virtual character being located in the environment below the second temperature threshold is longer than the first effect duration, a fourth temperature special effect is added to the remaining portion, the remaining portion is reduced, and the consumed portion is increased.

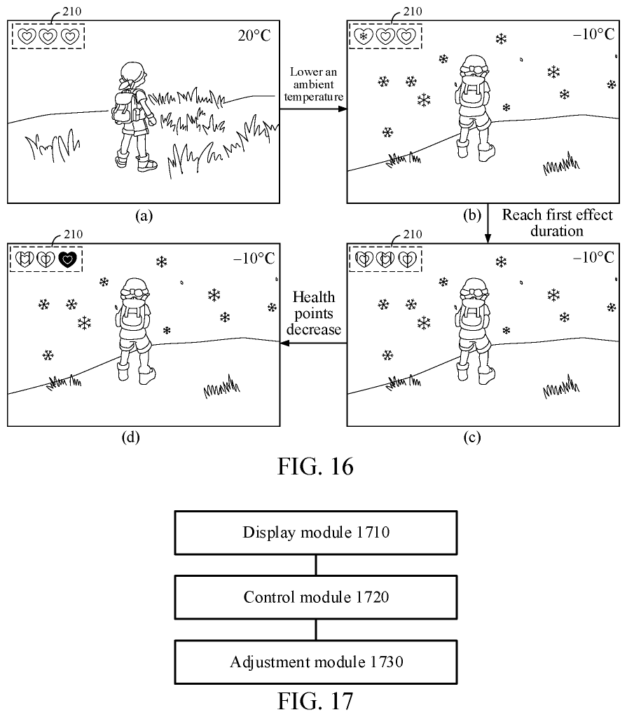

Exemplarily, the second temperature threshold is a preset value, for example, set to zero degrees Celsius. As shown in (a) in FIG. 16, the player-controlled virtual character is located in an environment above the second temperature threshold, a current temperature is 20 degrees Celsius, and health points 210 remain unchanged.

As shown in (b) in FIG. 16, the player-controlled virtual character is located in a snowy mountain environment, and an ambient temperature of the snowy mountain environment is −10 degrees Celsius, which is below the second temperature threshold. It is assumed that the first effect duration is 20 seconds. When duration of the player-controlled virtual character being located in an environment of −10 degrees Celsius is shorter than 20 seconds, the third temperature special effect, such as a frost mask special effect, is added to the remaining portion of the health points 210. As the duration of the player-controlled virtual character being located in the environment of −10 degrees Celsius gradually increases, the remaining portion of the health points 210 that is covered by the third temperature special effect gradually increases, until the duration of the player-controlled virtual character being located in the environment of −10 degrees Celsius is equal to 20 seconds, the third temperature special effect completely covers the remaining portion of the health points 210.

When the duration of the player-controlled virtual character being located in the environment of −10 degrees Celsius is longer than 20 seconds, a fourth temperature special effect, such as a blue special effect, is added to the entire remaining portion of the health points 210. As shown in (c) in FIG. 16, the blue special effect is represented by filling with vertical line hatching. In addition, as the duration of the player-controlled virtual character being located in the environment of −10 degrees Celsius gradually increases, the remaining portion of the health points 210 decreases, and the consumed portion increases. As shown in (d) in FIG. 16, the health points 210 decrease from 3 points to 2 points. If the player-controlled virtual character continues to be located in the environment of −10 degrees Celsius, the health points continue to decrease until the health points drop to zero.

In a process of adjusting the health points of the player-controlled virtual character in the world scene based on the activity of the player-controlled virtual character in the world scene, by setting different health point consumption mechanisms, different quantities of health points may be consumed based on scene situations that the player-controlled virtual character faces, to improve diversity and realism of health point consumption.

In some embodiments, the health point adjustment method further includes: adjusting the health points of the player-controlled virtual character when a weather condition around the player-controlled virtual character is a specified weather condition.

In an embodiment, the weather condition includes one or more of the following: a weather type and an ambient temperature.

The specified weather condition is a preset weather condition, such as rainy and snowy weather, sunny weather, or sandstorm weather. Exemplarily, when the player-controlled virtual character is located in an environment with rainy and snowy weather and an ambient temperature below zero degrees Celsius, the weather condition may negatively affect the player-controlled virtual character, for example, continuously reducing the health points, reducing a moving speed, or continuously consuming stamina points or accelerating consumption of the stamina points.

In some embodiments, the health point adjustment method further includes: modifying the weather condition around the player-controlled virtual character to a weather condition corresponding to the first pet character when the player-controlled virtual character is riding the first pet character and the first pet character is a first specified pet character or a pet character of a first specified type; and
keeping the health points of the player-controlled virtual character unchanged when the weather condition corresponding to the first pet character is not the specified weather condition.

In the embodiments of this application, some specified pet characters or pet characters of a specified type have the ability to affect the surrounding weather conditions. When the player-controlled virtual character is located in a harsh environment, the player may control the player-controlled virtual character to ride a specified pet character or a pet character of a specified type, to improve a current weather condition.

For example, when the player-controlled virtual character is in rainy and snowy weather, the player may control the player-controlled virtual character to ride the specified pet character or the pet character of the specified type (such as a pet character of a fire type), and the specified pet character or the pet character of the specified type may modify a surrounding weather type to a sunny weather type, and raise an ambient temperature to 20 degrees Celsius, to reduce or offset a negative effect of the rainy and snowy weather on the player-controlled virtual character.

For another example, when the player-controlled virtual character is in sunny weather, the sunny weather may negatively affect the player-controlled virtual character, for example, continuously reducing the health points, reducing a moving speed, or continuously consuming stamina points/accelerating consumption of the stamina points. In this case, the player may control the player-controlled virtual character to ride the specified pet character or the pet character of the specified type (such as a pet character of a water type), and the specified pet character or the pet character of the specified type may modify a surrounding weather type to a lightly rainy weather type, and lower a surrounding temperature to 10 degrees Celsius, to reduce or offset a negative effect of the sunny weather on the player-controlled virtual character.

When controlling the player-controlled virtual character to ride the first pet character, the player may select a suitable first pet character for riding. For example, an ambient temperature is raised to avoid a reduction in the health points caused by a cold weather, and an ambient temperature is lowered to avoid a reduction in the health points caused by a hot weather. This improves the strategy of controlling the player-controlled virtual character to ride the pet character by the player.

The health points of the player-controlled virtual character are adjusted with reference to the weather condition around the player-controlled virtual character, to improve realism of health point adjustment. In addition, a health point adjustment overcoming mechanism is provided for the player with reference to the weather condition corresponding to the first pet character on which the player-controlled virtual character is riding, to further improve the strategy of selecting a pet character by the player.

In conclusion, according to the method provided in this embodiment, the health points of the player-controlled virtual character in the world scene are adjusted based on the activity of the player-controlled virtual character in the world scene. This enhances the association between the activity of the player-controlled virtual character and the health points of the player-controlled virtual character, and enhances immersive experience of the player.

In the foregoing embodiments, operations with a same reference number may be considered as a same operation. The embodiment corresponding to FIG. 3, the embodiment corresponding to FIG. 4, the embodiment corresponding to FIG. 5, the embodiment corresponding to FIG. 9, and the embodiment corresponding to FIG. 10 may be independently implemented, or may be implemented in a combination. This is not limited in this application.

FIG. 17 is a block diagram of a health point adjustment apparatus according to an exemplary embodiment of this application. The apparatus may be implemented as a computer device or a part of a computer device through software, hardware, or a combination of software and hardware. The apparatus includes:
a display module 1710, configured to display a player-controlled virtual character located in a world scene and health points of the player-controlled virtual character, the player-controlled virtual character possessing a first pet character, and the health points indicating a health attribute of the player-controlled virtual character in the world scene and a round-based battle scene;
a control module 1720, configured to control, in response to a trigger operation for a round-based battle, the first pet character to engage in the round-based battle with a second pet character in the round-based battle scene; and
an adjustment module 1730, configured to adjust the health points of the player-controlled virtual character based on a battle result between the first pet character and the second pet character.

In an embodiment, the adjustment module 1730 is configured to increase or maintain the health points of the player-controlled virtual character based on a first battle result, the first battle result being a battle result indicating that the first pet character defeats the second pet character; or reduce the health points of the player-controlled virtual character based on a second battle result, the second battle result being a battle result indicating that the first pet character is defeated by the second pet character.

In an embodiment, a type of the second pet character is a wild type or a captured type, the second pet character of the wild type is a pet character that is not captured, and the second pet character of the captured type is a pet character captured by a virtual character other than the player-controlled virtual character. The adjustment module 1730 is configured to keep the health points of the player-controlled virtual character unchanged based on the first battle result when the type of the second pet character is the wild type; or increase the health points of the player-controlled virtual character based on the first battle result when the type of the second pet character is the captured type.

In an embodiment, character levels of the first pet character and the second pet character includes at least one level. The adjustment module 1730 is configured to increase the health points of the player-controlled virtual character by a j^{th} step size based on the first battle result when the character level of the second pet character is an i^{th} level; or
the adjustment module 1730 is configured to reduce the health points of the player-controlled virtual character by a k^{th} step size based on the second battle result when the character level of the first pet character is the i^{th} level, i, j, and k being positive integers, and a preset correspondence existing between i and j and a preset correspondence existing between i and k.

In an embodiment, the display module 1710 is further configured to display health points of the player-controlled virtual character in the round-based battle scene based on the health points of the player-controlled virtual character in the world scene after switching to the round-based battle scene; and display the health points of the player-controlled virtual character in the world scene based on the health points of the player-controlled virtual character in the round-based battle scene after exiting the round-based battle scene.

In an embodiment, the display module 1710 is configured to display, when the first pet character has a negative buff state, that the health points of the player-controlled virtual character in the world scene continuously decrease within first duration after exiting the round-based battle scene, the negative buff state being a state in which a battle capability of the first pet character is reduced.

In an embodiment, the display module 1710 is configured to display, when the player-controlled virtual character has a negative buff state before switching to the round-based battle scene, that the health points of the player-controlled virtual character in the round-based battle scene and health points of the first pet character continuously decrease within second duration after switching to the round-based battle scene, the negative buff state being a state in which a battle capability of the first pet character is reduced.

In an embodiment, the negative buff state includes at least one of the following: poisoned, burned, frozen, confused, infected, bound, and bleeding.

In an embodiment, the display module 1710 is configured to display, when the first pet character has a positive buff state, that the health points of the player-controlled virtual character in the world scene continuously increase within third duration after exiting the round-based battle scene, the positive buff state being a state in which a battle capability of the first pet character is enhanced.

In an embodiment, the display module 1710 is configured to display, when the player-controlled virtual character has a positive buff state before switching to the round-based battle scene, that the health points of the player-controlled virtual character in the round-based battle scene and health points of the first pet character continuously increase within fourth duration after switching to the round-based battle scene, the positive buff state being a state in which a battle capability of the first pet character is enhanced.

In an embodiment, the positive buff state includes at least one of the following: gradual healing, encouragement, assistance, eating, and idling.

In an embodiment, the round-based battle scene corresponds to a health point upper limit, and the health points of the player-controlled virtual character in the world scene are a first value.

The display module 1710 is configured to display, when the first value is less than or equal to the health point upper limit, the health points of the player-controlled virtual character in the round-based battle scene as the first value based on the health points of the player-controlled virtual character in the world scene after switching to the round-based battle scene; or display, when the first value is greater than the health point upper limit, the health points of the player-controlled virtual character in the round-based battle scene as a second value based on the health points of the player-controlled virtual character in the world scene after switching to the round-based battle scene, the second value being a value corresponding to the health point upper limit.

In an embodiment, different round-based battle scenes correspond to different health point upper limits.

In an embodiment, the display module 1710 is further configured to display first prompt information during the battle between the first pet character and the second pet character when the health points are less than a first threshold.

In an embodiment, the first prompt information includes at least one of the following: a prompt message, current health points, and a prompt special effect.

In an embodiment, the adjustment module 1730 is further configured to adjust the health points of the player-controlled virtual character in the world scene based on an activity of the player-controlled virtual character in the world scene.

In an embodiment, the health points include a remaining portion and a consumed portion. The remaining portion is configured for representing current remaining health points, and the consumed portion is configured for representing consumed health points. The adjustment module 1730 is configured to reduce the remaining portion and increase the consumed portion when the player-controlled virtual character is drowning in a water environment; reduce the remaining portion and increase the consumed portion when the player-controlled virtual character is attacked by a pet character of a wild type, the pet character of the wild type being a pet character that is not captured; reduce the remaining portion and increase the consumed portion when the player-controlled virtual character falls from the air to the ground; or reduce the remaining portion and increase the consumed portion when the player-controlled virtual character is affected by an ambient temperature.

In an embodiment, the adjustment module 1730 is further configured to adjust the health points of the player-controlled virtual character when a weather condition around the player-controlled virtual character is a specified weather condition.

In an embodiment, the adjustment module 1730 is further configured to modify the weather condition around the player-controlled virtual character to a weather condition corresponding to the first pet character when the player-controlled virtual character is riding the first pet character and the first pet character is a first specified pet character or a pet character of a first specified type.

The adjustment module 1730 is further configured to keep the health points of the player-controlled virtual character unchanged when the weather condition corresponding to the first pet character is not the specified weather condition.

In this embodiment, a description is made by using one display module 1710, one control module 1720, and one adjustment module 1730 as an example, and a quantity of the display module 1710, a quantity of the control module 1720, and a quantity of the adjustment module 1730 are not limited.

For description of functions of the display module 1710, refer to content of operation 310 in the embodiment in FIG. 3, content of operation 325 and operation 340 in the embodiment in FIG. 5, and content of operation 321 in the embodiment in FIG. 9.

For description of functions of the control module 1720, refer to content of operation 320 in the embodiment in FIG. 3.

For description of functions of the adjustment module 1730, refer to content of operation 330 in the embodiment in FIG. 3, content of operation 332 in the embodiment in FIG. 4, and content of operation 300 in the embodiment in FIG. 10.

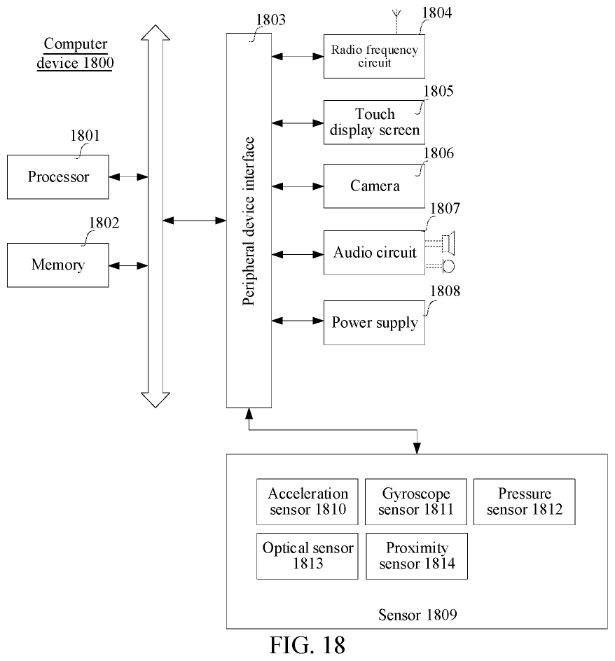

FIG. 18 is a structural block diagram of a computer device 1800 according to an exemplary embodiment of this application. The computer device 1800 may be a portable mobile terminal, such as a smartphone, a tablet computer, an MP3 player, or an MP4 player. The computer device 1800 may alternatively be referred to as user equipment, a portable terminal, or the like.

Typically, the computer device 1800 includes: a processor 1801 and a memory 1802.

The processor 1801 may include one or more processing cores, such as a 4-core processor or an 8-core processor. The processor 1801 may be implemented in at least one hardware form of a digital signal processor (DSP), a field-programmable gate array (FPGA), and a programmable logic array (PLA). The processor 1801 may alternatively include a main processor and a coprocessor. The main processor is a processor configured to process data in an awaken state, which is also referred to as a central processing unit (CPU). The coprocessor is a low-power processor configured to process data in a standby mode. In some embodiments, the processor 1801 may be integrated with a graphics processing unit (GPU), which is responsible for rendering and drawing a content required to be displayed on a display screen. In some embodiments, the processor 1801 may further include an AI processor. The AI processor is configured to perform computing operations related to machine learning.

The memory 1802 may include one or more computer-readable storage media. The computer-readable storage medium may be tangible and non-transitory. The memory 1802 may further include a high-speed random-access memory, as well as a non-volatile memory, such as one or more disk storage devices or flash storage devices. In some embodiments, the non-transitory computer-readable storage medium in the memory 1802 is configured to store at least one instruction. The at least one instruction is executed by the processor 1801 to implement the health point adjustment method provided in the embodiments of this application.

In some embodiments, the computer device 1800 may further include: a peripheral device interface 1803 and at least one peripheral device. Specifically, the peripheral device includes at least one of a radio frequency (RF) circuit 1804, a touch display screen 1805, a camera 1806, an audio circuit 1807, and a power supply 1808.

The peripheral interface 1803 may be configured to connect at least one peripheral device related to I/O to the processor 1801 and the memory 1802. In some embodiments, the processor 1801, the memory 1802, and the peripheral device interface 1803 are integrated on a same chip or circuit board. In some other embodiments, any one or two of the processor 1801, the memory 1802, and the peripheral device interface 1803 may be implemented on an independent chip or circuit board. This is not limited in this embodiment.

The RF circuit 1804 is configured to receive and transmit an RF signal, which is also referred to as an electromagnetic signal. The RF circuit 1804 communicates with a communication network and another communication device via electromagnetic signals. The RF circuit 1804 converts an electric signal into an electromagnetic signal for transmission, or converts a received electromagnetic signal into an electric signal. In an embodiment, the RF circuit 1804 includes: an antenna system, an RF transceiver, one or more amplifiers, a tuner, an oscillator, a DSP, a codec chip set, a subscriber identity module card, and the like. The RF circuit 1804 may communicate with another terminal by using at least one wireless communication protocol. The wireless communication protocol includes, but is not limited to, the World Wide Web, a metropolitan area networks, an intranet, various generations of mobile communication networks (2G, 3G, 4G, and 5G), a wireless local area network, and/or a wireless fidelity (Wi-Fi) network. In some embodiments, the RF circuit 1804 may further include a circuit related to near field communication (NFC). This is not limited in this application.

The touch display screen 1805 is configured to display a UI. The UI may include graphics, text, icons, videos, and any combination thereof. The touch display screen 1805 further has a capability to collect a touch signal on or above a surface of the touch display screen 1805. The touch signal may be inputted, as a control signal, into the processor 1801 for processing. The touch display screen 1805 is configured to provide a virtual button and/or a virtual keyboard, which is also referred to as a soft button and/or a soft keyboard. In some embodiments, one touch display screen 1805 may be disposed on a front panel of the computer device 1800. In some other embodiments, at least two touch display screens 1805 may be disposed on different surfaces of the computer device 1800 respectively or in a folded design. In some embodiments, the touch display screen 1805 may be a flexible display screen, which is disposed on a curved surface or a folded surface of the computer device 1800. The touch display screen 1805 may alternatively be configured as a non-rectangular irregular pattern, namely, a special-shaped screen. The touch display screen 1805 may be made of a material such as a liquid crystal display (LCD), an organic light-emitting diode (OLED), or the like.

The camera 1806 is configured to collect images or videos. In an embodiment, the camera 1806 includes a front-facing camera and a rear-facing camera. Typically, the front-facing camera is configured to implement video calls or selfies. The rear-facing camera is configured to take photos or record videos. In some embodiments, at least two rear-facing cameras are provided, each being any one of a main camera, a depth camera, and a wide-angle camera, to implement a background blurring function of a combination of the main camera and the depth camera, and panoramic shooting and VR shooting functions of a combination of the main camera and the wide-angle camera. In some embodiments, the camera 1806 may further include a flash. The flash may be a single-color temperature flash or a dual-color temperature flash. The dual-color temperature flash is a combination of a warm light flash and a cold light flash, and may be configured to compensate light at different color temperatures.

The audio circuit 1807 is configured to provide an audio interface between a user and the computer device 1800. The audio frequency circuit 1807 may include a microphone and a speaker. The microphone is configured to collect sound waves of a user and an environment, and convert the sound waves into an electrical signal and input the electrical signal into the processor 1801 for processing, or input the electrical signal into the RF circuit 1804 to achieve voice communication. For stereo collection or noise reduction, a plurality of microphones may be respectively disposed at different parts of the computer device 1800. The microphone may further be an array microphone or an omnidirectional capture microphone. The speaker is configured to convert an electric signal from the processor 1801 or the RF circuit 1804 into sound waves. The speaker may be a conventional thin-film speaker or a piezoelectric ceramic speaker. When the speaker is a piezoelectric ceramic speaker, the speaker can not only convert an electrical signal into sound waves audible to a human being, but also convert an electrical signal into sound waves inaudible to the human being for a purpose such as ranging. In some embodiments, the audio circuit 1807 may further include an earphone jack.

The power supply 1808 is configured to supply power to the components of the computer device 1800. The power supply 1808 may be an alternating current battery, a direct current battery, a disposable battery, or a rechargeable battery. When the power supply 1808 includes a rechargeable battery, the rechargeable battery may be a wired rechargeable battery or a wireless rechargeable battery. The wired rechargeable battery is a battery charged through a wired cable. The wireless rechargeable battery is a battery charged through a wireless coil. The rechargeable battery may further support a fast-charging technology.

In some embodiments, the computer device 1800 further includes one or more sensors 1809. The one or more sensors 1809 include, but are not limited to, an acceleration sensor 1810, a gyroscope sensor 1811, a pressure sensor 1812, an optical sensor 1813, and a proximity sensor 1814.

The acceleration sensor 1810 may detect acceleration on three coordinate axes of a coordinate system established based on the computer device 1800. For example, the acceleration sensor 1810 is configured to detect components of gravity acceleration on the three coordinate axes. The processor 1801 may control the touch display screen 1805 to display the UI in a landscape view or a portrait view based on a gravity acceleration signal collected by the acceleration sensor 1810. The acceleration sensor 1810 may further be configured to collect motion data of a game or the user.

The gyroscope sensor 1811 may detect a body direction and a rotation angle of the computer device 1800. The gyroscope sensor 1811 may cooperate with the acceleration sensor 1810 to collect a three-dimensional (3D) action performed by the user on the computer device 1800. The processor 1801 may implement the following functions based on the data collected by the gyroscope sensor 1811: motion sensing (such as changing the UI based on a tilt operation of the user), image stabilization during photographing, game control, and inertial navigation.

The pressure sensor 1812 may be disposed on a side frame of the computer device 1800 and/or under the touch display screen 1805. When disposed on the side frame of the computer device 1800, the pressure sensor 1812 may detect a holding signal of the user on the computer device 1800, and left/right hand recognition or a quick operation may be performed based on the holding signal. When the pressure sensor 1812 is disposed under the touch display screen 1805, an operable control on the UI may be controlled based on a pressure operation performed by the user on the touch display screen 1805. The operable control includes at least one of a button control, a scroll-bar control, an icon control, and a menu control.

The optical sensor 1813 is configured to collect an ambient light intensity. In an embodiment, the processor 1801 may control display brightness of the touch display screen 1805 based on the ambient light intensity collected by the optical sensor 1813. Specifically, when the ambient light intensity is high, the display brightness of the touch display screen 1805 is increased. When the ambient light intensity is low, the display brightness of the touch display screen 1805 is reduced. In another embodiment, the processor 1801 may further dynamically adjust camera parameters of the camera 1806 based on the ambient light intensity collected by the optical sensor 1813.

The proximity sensor 1814, also referred to as a distance sensor, is typically disposed on a front surface of the computer device 1800. The proximity sensor 1814 is configured to collect a distance between the user and the front surface of the computer device 1800. In an embodiment, when the proximity sensor 1814 detects that the distance between the user and the front surface of the computer device 1800 gradually decreases, the processor 1801 controls the touch display screen 1805 to switch from a screen-on state to a screen-off state. When the proximity sensor 1814 detects that the distance between the user and the front surface of the computer device 1800 gradually increases, the processor 1801 controls the touch display screen 1805 to switch from the screen-off state to the screen-on state.

A person skilled in the art may understand that the structure shown in this embodiment does not constitute a limitation on the computer device 1800, and the computer device may include more or fewer components than those shown in the figure, some components are combined, or a different component arrangement is employed.

The embodiments of this application further provide a computer device. The computer device includes: a processor and a memory. The memory has at least one program stored therein. The processor is configured to execute the at least one program in the memory to implement the health point adjustment method provided in the foregoing method embodiments.

The embodiments of this application further provide a computer-readable storage medium. The computer-readable storage medium has at least one program stored therein, and the at least one program is loaded and executed by a processor to implement the health point adjustment method provided in the foregoing method embodiments.

The embodiments of this application further provide a computer program product. The computer program product includes computer instructions. The computer instructions are stored in a computer-readable storage medium. A processor obtains the computer instructions from the computer-readable storage medium, and executes the computer instructions to implement the health point adjustment method provided in the foregoing method embodiments.

In this application, the term “module” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules. In addition, each module may be a part of an overall module including a function of the module. The term “plurality of” mentioned herein means two or more. The term “and/or” describes an association relationship between associated objects and indicates that three relationships may exist. For example, A and/or B may indicate the following three cases: Only A exists, both A and B exist, and only B exists. The character “/” typically represents an “or” relationship between associated objects.

A person skilled in the art will appreciate that in one or more of the foregoing examples, the functions described in the embodiments of this application may be implemented by using hardware, software, firmware, or any combination thereof. When implemented by software, these functions may be stored in a computer-readable storage medium or may be used as one or more instructions or code in a computer-readable storage medium for transmission. The computer-readable storage medium includes a computer storage medium and a communication medium. The communication medium includes any medium that facilitates transfer of a computer program from one place to another place. The storage medium may be any available medium accessible to a general-purpose or a dedicated computer.

The above are merely exemplary embodiments of this application, but are not intended to limit this application. Any modification, equivalent replacement, improvement, or the like made within the spirit and principle of this application fall within the scope of protection of this application.

What is claimed is:

1. A method for adjusting health points of a player-controlled virtual character in a virtual battle performed by a computer device and comprising:
displaying a graphical user interface including a player-controlled virtual character located in a world scene and health points of the player-controlled virtual character, the player-controlled virtual character possessing a first pet character, and the health points indicating a health attribute of the player-controlled virtual character;
in response to a trigger operation for a round-based battle on the graphical user interface, switching from the world scene to a round-based battle scene;
updating health points of the player-controlled virtual character in the round-based battle scene based on the health points of the player-controlled virtual character in the world scene;
controlling the first pet character to engage in the round-based battle with a second pet character in the round-based battle scene;
adjusting the health points of the player-controlled virtual character in the round-based battle scene based on a battle result between the first pet character and the second pet character; and
updating the health points of the player-controlled virtual character in the world scene based on the health points of the player-controlled virtual character in the round-based battle scene after exiting the round-based battle scene.

2. The method according to claim 1, wherein the adjusting the health points of the player-controlled virtual character in the round-based battle scene based on a battle result between the first pet character and the second pet character comprises:
increasing the health points of the player-controlled virtual character in the round-based battle scene based on a first battle result, the first battle result indicating that the first pet character defeats the second pet character; and
reducing the health points of the player-controlled virtual character in the round-based battle scene based on a second battle result, the second battle result indicating that the first pet character is defeated by the second pet character.

3. The method according to claim 2, wherein a type of the second pet character is a captured type, and the second pet character of the captured type is a pet character captured by a virtual character other than the player-controlled virtual character; and
the increasing the health points of the player-controlled virtual character in the round-based battle scene based on a first battle result comprises:
increasing the health points of the player-controlled virtual character in the round-based battle scene based on the first battle result when the type of the second pet character is the captured type.

4. The method according to claim 2, wherein a character level of the first pet character and a character level of the second pet character comprises at least one level;
the increasing the health points of the player-controlled virtual character in the round-based battle scene based on a first battle result comprises:
increasing the health points of the player-controlled virtual character by a j^{th} step size based on the first battle result when the character level of the second pet character is an i^{th} level; and
the reducing the health points of the player-controlled virtual character based on a second battle result comprises:
reducing the health points of the player-controlled virtual character by a k^{th} step size based on the second battle result when the character level of the first pet character is the i^{th} level,
i, j, and k being positive integers, and a preset correspondence existing between i and j and a preset correspondence existing between i and k.

5. The method according to claim 1, wherein the updating the health points of the player-controlled virtual character in the world scene based on the health points of the player-controlled virtual character in the round-based battle scene after exiting the round-based battle scene comprises:
when the first pet character has a negative buff state, displaying that the health points of the player-controlled virtual character in the world scene continuously decrease within first duration,
the negative buff state being a state in which a battle capability of the first pet character is reduced.

6. The method according to claim 1, wherein the updating the health points of the player-controlled virtual character in the round-based battle scene based on the health points of the player-controlled virtual character in the world scene comprises:
when the player-controlled virtual character has a negative buff state before switching to the round-based battle scene, displaying that the health points of the player-controlled virtual character in the round-based battle scene and health points of the first pet character continuously decrease within second duration after switching to the round-based battle scene,
the negative buff state being a state in which a battle capability of the first pet character is reduced.

7. The method according to claim 1, wherein the updating the health points of the player-controlled virtual character in the world scene based on the health points of the player-controlled virtual character in the round-based battle scene after exiting the round-based battle scene comprises:
when the first pet character has a positive buff state, displaying that the health points of the player-controlled virtual character in the world scene continuously increase within third duration after exiting the round-based battle scene,
the positive buff state being a state in which a battle capability of the first pet character is enhanced.

8. The method according to claim 1, wherein the updating the health points of the player-controlled virtual character in the round-based battle scene based on the health points of the player-controlled virtual character in the world scene after switching to the round-based battle scene comprises:
when the player-controlled virtual character has a positive buff state before switching to the round-based battle scene, displaying that the health points of the player-controlled virtual character in the round-based battle scene and health points of the first pet character continuously increase within fourth duration after switching to the round-based battle scene,
the positive buff state being a state in which a battle capability of the first pet character is enhanced.

9. The method according to claim 1, wherein the round-based battle scene corresponds to a health point upper limit, and the health points of the player-controlled virtual character in the world scene are a first value; and
the updating the health points of the player-controlled virtual character in the round-based battle scene based on the health points of the player-controlled virtual character in the world scene after switching to the round-based battle scene comprises:
when the first value is less than or equal to the health point upper limit, displaying the health points of the player-controlled virtual character in the round-based battle scene as the first value based on the health points of the player-controlled virtual character in the world scene after switching to the round-based battle scene; and
when the first value is greater than the health point upper limit, displaying the health points of the player-controlled virtual character in the round-based battle scene as a second value based on the health points of the player-controlled virtual character in the world scene after switching to the round-based battle scene, the second value being a value corresponding to the health point upper limit.

10. The method according to claim 1, further comprising:
displaying first prompt information during the virtual battle between the first pet character and the second pet character when the health points are less than or equal to a first threshold.

11. A computer device, comprising: a processor and a memory, the memory having at least one program stored therein; and the processor being configured to execute the at least one program in the memory, to implement a method for adjusting health points of a player-controlled virtual character in a virtual battle including:
displaying a graphical user interface including a player-controlled virtual character located in a world scene and health points of the player-controlled virtual character, the player-controlled virtual character possessing a first pet character, and the health points indicating a health attribute of the player-controlled virtual character;
in response to a trigger operation for a round-based battle on the graphical user interface, switching from the world scene to a round-based battle scene;
updating health points of the player-controlled virtual character in the round-based battle scene based on the health points of the player-controlled virtual character in the world scene;
controlling the first pet character to engage in the round-based battle with a second pet character in the round-based battle scene;
adjusting the health points of the player-controlled virtual character in the round-based battle scene based on a battle result between the first pet character and the second pet character; and
updating the health points of the player-controlled virtual character in the world scene based on the health points of the player-controlled virtual character in the round-based battle scene after exiting the round-based battle scene.

12. The computer device according to claim 11, wherein the adjusting the health points of the player-controlled virtual character in the round-based battle scene based on a battle result between the first pet character and the second pet character comprises:
increasing the health points of the player-controlled virtual character in the round-based battle scene based on a first battle result, the first battle result indicating that the first pet character defeats the second pet character; and
reducing the health points of the player-controlled virtual character in the round-based battle scene based on a second battle result, the second battle result indicating that the first pet character is defeated by the second pet character.

13. The computer device according to claim 12, wherein a type of the second pet character is a captured type, and the second pet character of the captured type is a pet character captured by a virtual character other than the player-controlled virtual character; and
the increasing the health points of the player-controlled virtual character in the round-based battle scene based on a first battle result comprises:
increasing the health points of the player-controlled virtual character in the round-based battle scene based on the first battle result when the type of the second pet character is the captured type.

14. The computer device according to claim 12, wherein a character level of the first pet character and a character level of the second pet character comprises at least one level;
the increasing the health points of the player-controlled virtual character in the round-based battle scene based on a first battle result comprises:
increasing the health points of the player-controlled virtual character by a j^{th} step size based on the first battle result when the character level of the second pet character is an i^{th} level; and
the reducing the health points of the player-controlled virtual character based on a second battle result comprises:
reducing the health points of the player-controlled virtual character by a k^{th} step size based on the second battle result when the character level of the first pet character is the i^{th} level,
i, j, and k being positive integers, and a preset correspondence existing between i and j and a preset correspondence existing between i and k.

15. The computer device according to claim 11, wherein the updating the health points of the player-controlled virtual character in the world scene based on the health points of the player-controlled virtual character in the round-based battle scene after exiting the round-based battle scene comprises:
when the first pet character has a negative buff state, displaying that the health points of the player-controlled virtual character in the world scene continuously decrease within first duration,
the negative buff state being a state in which a battle capability of the first pet character is reduced.

16. The computer device according to claim 11, wherein the updating the health points of the player-controlled virtual character in the round-based battle scene based on the health points of the player-controlled virtual character in the world scene comprises:
when the player-controlled virtual character has a negative buff state before switching to the round-based battle scene, displaying that the health points of the player-controlled virtual character in the round-based battle scene and health points of the first pet character continuously decrease within second duration after switching to the round-based battle scene,
the negative buff state being a state in which a battle capability of the first pet character is reduced.

17. The computer device according to claim 11, wherein the updating the health points of the player-controlled virtual character in the world scene based on the health points of the player-controlled virtual character in the round-based battle scene after exiting the round-based battle scene comprises:
when the first pet character has a positive buff state, displaying that the health points of the player-controlled virtual character in the world scene continuously increase within third duration after exiting the round-based battle scene,
the positive buff state being a state in which a battle capability of the first pet character is enhanced.

18. The computer device according to claim 11, wherein the updating the health points of the player-controlled virtual character in the round-based battle scene based on the health points of the player-controlled virtual character in the world scene after switching to the round-based battle scene comprises:
when the player-controlled virtual character has a positive buff state before switching to the round-based battle scene, displaying that the health points of the player-controlled virtual character in the round-based battle scene and health points of the first pet character continuously increase within fourth duration after switching to the round-based battle scene,
the positive buff state being a state in which a battle capability of the first pet character is enhanced.

19. The computer device according to claim 11, wherein the round-based battle scene corresponds to a health point upper limit, and the health points of the player-controlled virtual character in the world scene are a first value; and
the updating the health points of the player-controlled virtual character in the round-based battle scene based on the health points of the player-controlled virtual character in the world scene after switching to the round-based battle scene comprises:
when the first value is less than or equal to the health point upper limit, displaying the health points of the player-controlled virtual character in the round-based battle scene as the first value based on the health points of the player-controlled virtual character in the world scene after switching to the round-based battle scene; and
when the first value is greater than the health point upper limit, displaying the health points of the player-controlled virtual character in the round-based battle scene as a second value based on the health points of the player-controlled virtual character in the world scene after switching to the round-based battle scene, the second value being a value corresponding to the health point upper limit.

20. A non-transitory computer-readable storage medium, having at least one program stored therein, and the at least one program, when loaded and executed by a processor of a computer device, causing the computer device to implement a method for adjusting health points of a player-controlled virtual character in a virtual battle including:
displaying a graphical user interface including a player-controlled virtual character located in a world scene and health points of the player-controlled virtual character, the player-controlled virtual character possessing a first pet character, and the health points indicating a health attribute of the player-controlled virtual character;
in response to a trigger operation for a round-based battle on the graphical user interface, switching from the world scene to a round-based battle scene;
updating health points of the player-controlled virtual character in the round-based battle scene based on the health points of the player-controlled virtual character in the world scene;
controlling the first pet character to engage in the round-based battle with a second pet character in the round-based battle scene;
adjusting the health points of the player-controlled virtual character in the round-based battle scene based on a battle result between the first pet character and the second pet character; and
updating the health points of the player-controlled virtual character in the world scene based on the health points of the player-controlled virtual character in the round-based battle scene after exiting the round-based battle scene.
